(19) United States
(12) Patent Application Publication
(10) Pub. No.: US 2005/0079477 A1
(43) Pub. Date: Apr. 14, 2005

(54) Interactions for electronic learning system

(75) Inventors: Michael E. Diesel, Saugus, MA (US); Shane W. Hill, St. Marys, KS (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: automatic e-Learning, LLC

(21) Appl. No.: 10/918,208

(22) Filed: Aug. 12, 2004

Related U.S. Application Data
(63) Continuation-in-part of application No. 10/287,441, filed on Nov. 1, 2002.
(60) Provisional application No. 60/334,714, filed on Nov. 1, 2001.
(60) Provisional application No. 60/400,606, filed on Aug. 1, 2002.

(51) Int. Cl. G09B 3/00

(52) U.S. Cl. 434/350; 434/362

(57) ABSTRACT

A technique for creating interactions is provided. An interaction is defined in a data table. The data table may be stored in a word processing document. A type of interaction may be specified in the data table. The contents of the table are assessed to determine if any indicators are present, which would identify the type of interaction specified. The table contents may be stored into a string or an array. An interaction is created, based on the stored table contents. This allows developers of computer information, such as e-Learning, technical documents, or web pages to create interactions quickly and easily for their users.

### RELATED APPLICATIONS

This application claims the benefit of U.S. Provisional Application No. 60/494,760, filed Aug. 12, 2003 and is a Continuation-in-Part of U.S. Application Ser. No. 10/287,441, filed Nov. 1, 2002, which claims the benefit of U.S. Provisional Application No. 60/400,606, filed Aug. 1, 2002 and U.S. Provisional Application No. 60/334,714, filed Nov. 1, 2001. The entire teachings of the above applications are incorporated herein by reference.

### BACKGROUND

In today's dynamic global environment, the critical nature of speed and accuracy can mean the difference between success and failure for a new product or even a company. In order to achieve success in this environment, a company must ensure that its employees are aligned with its goals and trained to meet the company's needs. Consumers, for example, want specific information quickly about a product or service, and a company needs to ensure that its representatives are trained and informed so that they can successfully serve their customers' demands. Thus, a company must undertake to prepare and train employees such that they will be able to apply their skills and knowledge effectively in the company's research, development, manufacturing, marketing and sales channels.

While traditional in-person instruction for employee training can be effective, it is often costly, inconvenient, and cumbersome for today's fast-paced businesses. Increasingly, companies and organizations search for a more versatile, comprehensive and cost effective solution to provide relevant training. With the advent of e-learning, the problem is partially solved.

Computer learning systems provide a useful medium through which a company can offer a vast array of educational services to its personnel, in a manner that is customized to meet the specific and dynamic needs of that company. Users will log on to classes, watch animated simulations, take computer-based tests, and can do this from the convenience of a home, office or virtually anywhere. Thus, e-learning naturally and seamlessly integrates education and training into the lives of the individual users.

As the number of users participating in e-learning increases, the need for effective computer-based testing and evaluation also grows. Unfortunately, the creation and maintenance of a computer learning system dedicated to user evaluation can be expensive and complicated. In general, content developers are restricted in their ability to efficiently create content that is flexible and effective for interactions, such as evaluations, quizzes and tests. The current web-content development schemes have specific requirements for handling and using interactive content. These requirements limit interactivity and decrease the instructional value of computer-based learning.

Further, current computer-based testing and evaluation methods typically rely on the tradition of paper and pencil examinations. These testing methods, such as multiple choice, multiple select, true/false and “highlight the graphic” questions, neither provide a comprehensive measurement of a student's retention, nor engage the student. While the testing methods provide a limited means of evaluation, they do not meet the needs set forth in instructional design because they restrict evaluation to generalized knowledge of complex subjects. This evaluation limitation confines test developers to examination of only high-level knowledge of a subject, rather than the full panoply of the tested subject matter. Correspondingly, these exams provide only high-level information with regard to user competence in a given subject.

Moreover, many web-based e-learning applications do not provide comprehensive interface navigation options. As a result, users are forced to manipulate only the mouse pointer to participate in the test environment and they are restricted from access to course content during the quizzes or interactions. In addition, these limitations affect the creation of aesthetically engaging testing environments that can enhance the user's learning experience, and they restrict the use of multimedia elements to specific formats.

Although e-learning provides companies and institutions with more options to create a learning environment that is aligned with their needs, it also presents a host of problems involved in creating this environment efficiently and effectively. One of the biggest challenges in creating e-learning courses that are tailored to a particular industry or corporation's needs is that it requires highly trained graphical user interface designers and programmers to create an effective e-learning course. This creation process, therefore, can be cost prohibitive. Because such graphical designers and programmers are often poorly versed in the needs and demands of a particular industry or corporation, the final e-learning course may not effectively satisfy the needs or demands of the corporation. As a result, a company, for example, may request a series of content updates to the e-learning course to incorporate certain features that were overlooked when the e-learning course was initially created. Frequent updates can cost the company dearly. Ideally, the company's personnel could create and update their own e-learning course so that the company could effectively tailor the course to meet its needs. In general, however, the average company employee does not possess the programming skills to create or update the e-learning system. Moreover, the vast amount of time it would take for employees to create an e-learning course from scratch may be impractical for the company. Therefore, it is typically not a cost effective option for a company to have its own employees create their e-learning courses.

Thus, one of the most complicated aspects of e-learning is finding a scheme in which the cost benefit analysis accommodates all participants, e.g. the learners, the businesses, and the software providers. At this time, the currently available schemes do not provide a learner-friendly, provider-friendly and financially-effective solution to provide easy, quick and effective access to e-learning.

### SUMMARY

The present system provides a technique for creating interactions. The interactions may be created using content stored in a data table. In particular, a course developer can create, edit, and preview an interaction that has been specified in a data table in a word processing document or software program. The content stored in the table is extracted and processed to create the interaction. With this technique, complex interactions can be developed in a matter of minutes using a word processor. By simply entering question and answers in a table, an interaction can be created. In this way, developers of computer information, such as e-Learning, technical documents, or web pages, may efficiently create interactions for their users.

The interaction can correspond to a variety of types of interactions. For example, the interaction type may be a multiple choice, multiple select, dichotomous, ordered list, or matching interaction. A multiple choice interaction may be a fill in the blank interaction. A matching interaction may be any drag and drop, label drag and drop, puzzle or building block interaction. The puzzle interaction may correspond to a jigsaw puzzle.

The interaction types may be graphic-independent. Each interaction may be associated with a suite of graphical objects. For example, a matching interaction may be associated with drag and drop objects, such as building blocks, puzzle pieces, labels and user supplied graphics. The system may detect the type of interaction specified based on a pattern detected in the table and generate an interaction that corresponds to the type of interaction detected. Thus, the system may enable developers to spend their time creating questions without expending time on creating the type of interaction and graphics. This data independence also allows developers to immediately preview and test individual questions to ensure functionality.

The system can allow developers to provide their own graphics. The developers may specify the filename and location of the file within a word processor table. The system can identify the specified graphic and associate it with the interaction.

The system can enable developers to specify hot spots using the data table for matching interactions. A hot spot or drop-zone is designated by specifying a pair of coordinates entered in a data table. The coordinates, for example, are used to determine a drop-zone for a graphical object, such as a puzzle piece.

The system can assess the content stored in the table to create the interaction. The system can analyze the content stored in the table to determine which type of an interaction corresponds to the interaction. The system may determine the type of interaction by detecting a pattern in the arrangement of the data, such as the arrangement of cells and rows. Further, the system may consider the content stored in the cells and identify indicators stored in the table that correspond to an interaction type. For example, the system may consider which cell contains a question and which cell contains an answer. Depending on which row the cell is stored in, the system may be able to decipher which type of interaction corresponds to the content stored in the table. The system may consider whether there cell contains any graphical coordinates in a cell, which might be indicative of a graphical object. The system may consider whether there is a character string in the cell that identifies the type of interaction, such as the string of characters “CORRECT”.

The system may analyze the content at intersections between rows and columns of the data table to determine the type of interaction. If an intersection of the row and column includes a particular character string, such as CORRECT, the system can identify whether the type of interaction is a matching interaction. For example, at the intersection between the answer row (such as text or developer-supplied graphics) and the question column (such as text or coordinates on a developer-supplied graphic) the system can identify whether the interaction type corresponds to a matching interaction. The intersection may include a character string, which indicates that this answer is correct for this question. The correct answer cells may further include feedback. Intersections between the answer row and question column may identify incorrect answer cells. The incorrect answer cells may further include feedback.

An interaction builder or handler can be used to extract the content from the table and assess the content to determine the type of interaction. When the content is extracted from the data table, it may be appropriate to store the content into a data structure, such as a string or array. The original arrangement of content stored in the data table (e.g. row/cell position) can be preserved in the string by dividing the string using delimiter characters. For example, rows can be defined in the string by defining a particular row delimiter character. Cells can be defined in the string using a specific cell delimiter character. In this way, the content can be stored and sorted using the delimiters to preserve its original arrangement from the table.

The content in the string may be parsed and stored into a two dimensional array. In particular, each element of the array can be defined as a row. Each element of the row can be defined as an array of cells. The rows and cells defined in the two dimensional array can preserve the original arrangement of the content stored in the table.

The system may use a player to generate the interaction using the contents stored in a data structure, such as the array. The player may be an XML player.

The system may be capable of enhancing the viewing experience of the user by causing any graphics associated with the interaction to be invisible on the user interface while they are loading. In this way, the sizing of the objects and the initialization of the interactive presentation may be hidden from the user. By setting the images to an invisible setting while they are loading, a viewer can have a smooth presentation.

The system may enable the user's learning experience to be enhanced by providing the user with versatile navigation techniques. For example, the user's learning experience may be enhanced by providing the user with the ability to navigate using one a variety of input devices, such as a keyboard or mouse. The system may enable the user, such as the learner, to navigate using one or more keystrokes. The system may allow for keyboard and mouse navigation both inter and intra-questions, e.g., selecting from a list of possible correct answers and for advancing or retreating through a sequential list of questions.

The system may include a granular scoring system that calculates answer percentages based on the number of correct elements in the test, rather than the number of incorrect answers divided by the total number of questions in the test. It may score on both a question-by-question and total test basis. This can allow for the granting of both full and partial credit, thereby offering a great deal more information about a user's depth of knowledge.

### BRIEF DESCRIPTION OF THE DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of the computer system architecture according to an embodiment of the invention.

FIG. 2 is a schematic block diagram software components associated with the interactive presentation.

FIG. 3 is a depiction of an interactive presentation displayed in a browser user interface.

FIG. 4 is a depiction of the animation-video region of the user interface.

FIG. 5 is a depiction of a text based dichotomous interaction.

FIG. 6 is a depiction of a text based multiple choice interaction.

FIG. 7 is a depiction of a graphical multiple choice interaction.

FIGS. 8A-B are depictions of text based multiple select interactions.

FIGS. 9A-B are depictions of graphical drag and drop interactions.

FIG. 10A is a depiction of a graphical puzzle interaction.

FIG. 10B is a depiction of a label matching interaction.

FIG. 11 is a depiction of a graphical ordered list interaction.

FIG. 12 is a depiction of a course navigation bar.

FIG. 13 is a depiction of the table of contents of the user interface.

FIG. 14 is a depiction of an aspect of the table of contents shown in FIG. 3.

FIG. 15 is a flow diagram depicting user interaction with the interactive presentation.

FIG. 16 is a flow diagram depicting the hyper-download process.

FIG. 17 is a flow diagram depicting an aspect of the hyper-download system.

FIG. 18 is a depiction of an example XML data reference link in the course structure file.

FIG. 19 is a depiction of an example of XML data associated with an anticipated page.

FIG. 20 is a depiction of an example of the resulting XML data in the course structure file.

FIG. 21 is a block diagram of the system architecture used to create an interactive presentation according to an embodiment of the invention.

FIG. 22 is a block diagram of an authoring environment according to an embodiment of FIG. 21.

FIG. 23 is a flow diagram depicting the steps associated with the CME application.

FIG. 24 is a depiction of a user interface of the CME application.

FIG. 25 is a depiction of a template manager user interface of the CME application.

FIG. 26 is a depiction of the time-coder user interface of the CME application.

FIG. 27 is a flow diagram depicting the steps associated with the x-builder application.

FIG. 28 is a depiction of the x-builder user interface depicting imported content stored in the common files database.

FIG. 29 is a depiction of the x-builder content editor interface.

FIG. 30 is a depiction of the x-builder application user interface.

FIG. 31 is a depiction of the x-builder application user interface.

FIG. 32 is a block diagram of the computer systems architecture used to create an interactive presentation according to an embodiment of the invention.

FIG. 33 is a block diagram of the software architecture of the XML player according to an embodiment of the invention.

FIG. 34 is a flow diagram depicting the authoring process associated with authoring system of FIG. 32.

FIG. 35 is a block diagram of the computer systems architecture used to create an interactive presentation according to an embodiment of the invention.

FIG. 36 is a depiction of a table corresponding to a dichotomous interaction.

FIG. 37 is a depiction of a dichotomous interaction displayed according to an embodiment of FIG. 36.

FIG. 38 is a depiction of the Knowledge Test graphical user interface.

FIGS. 38A-C are depictions of example data table content for a single question interaction.

FIG. 38D is a flow diagram depicting the process of specifying table content using the Knowledge Test software of FIG. 38.

FIG. 38E is a depiction of example table content for generating the multiple select interaction of FIGS. 8A-B.

FIG. 38F is a depiction of example table content used to generate feedback in an interaction.

FIG. 38G is a depiction of example table content used to reference feedback according to an embodiment of FIG. 38F.

FIG. 38H is a depiction of example table content used to generate remediation in an interaction.

FIG. 38I is a depiction of example table content used to reference a start point and end point in a Flash file.

FIG. 38J is a depiction of the interaction generated from the table content of FIG. 38H.

FIG. 38K is a depiction of example data table content for a multiple choice interaction.

FIG. 38L is a depiction of the multiple choice interaction generated from the a table content of FIG. 38K.

FIG. 38M is a depiction of example data table for a fill in the blank interaction.

FIG. 38N is a depiction of the fill in the blank exercise generated from example data table content of FIG. 38M.

FIG. 38O is a depiction of example data table for multiple choice interaction with a combination of graphical background and answers.

FIG. 38P is a depiction of the multiple choice interaction with a combination of graphical background and answers generated from the data table content of FIG. 38P.

FIG. 38Q is a depiction of a word processing table editor with a data table having graphical coordinates.

FIG. 38R is a depiction of example data table content with graphical coordinates specified in pairs.

FIG. 38S is a depiction of the interaction generated from the table content of FIG. 38R.

FIG. 38T is a depiction of example data table content for a building block interaction.

FIG. 38U is a depiction of the building block interaction generated from the data table content of FIG. 38T.

FIG. 38V is a depiction of a word processing table editor.

FIG. 38W is a depiction of example data table content used to generate the building block exercise of FIGS. 9A-B.

FIG. 38X is a depiction of example data table content for the ordered list interaction of FIG. 11.

FIG. 38Y is diagram depicting different features associated with the various types of interactive exercises.

FIG. 38Z is a depiction of example data table content for the puzzle interaction of FIG. 10A.

FIG. 39 is a flow diagram of the process of creating an interaction according to an embodiment of the invention.

FIG. 40 is a depiction of the software components associated with the XML player and interaction handler according to an embodiment of the invention.

FIG. 41 is a flow diagram depicting the process of storing variables from a question table into strings according to an embodiment of the invention.

FIG. 42 is a flow diagram of the process of determining a type of interaction based on the contents of a table according to an embodiment of the invention.

FIG. 43 is a flow diagram of the process of generating an interaction according to an embodiment of the invention.

FIG. 44 is a flow diagram of the process of scaling graphics used when loading an interaction.

FIG. 45 is a flow diagram depicting an aspect of the drag and drop process.

FIG. 46 is a flow diagram depicting the process of dragging a moving object on the screen.

FIG. 47 is a flow diagram depicting the process of dragging a reusable object.

FIG. 48 is a flow diagram depicting the process of dropping an object.

FIG. 49 is a flow diagram depicting the process of moving a building block object.

FIG. 50 is a flow diagram depicting the process of moving an object.

FIG. 51 is a flow diagram depicting the process of dropping an ordered list object.

FIG. 52 is a schematic diagram of the attributes stored in a string according to an embodiment of the invention.

### DETAILED DESCRIPTION

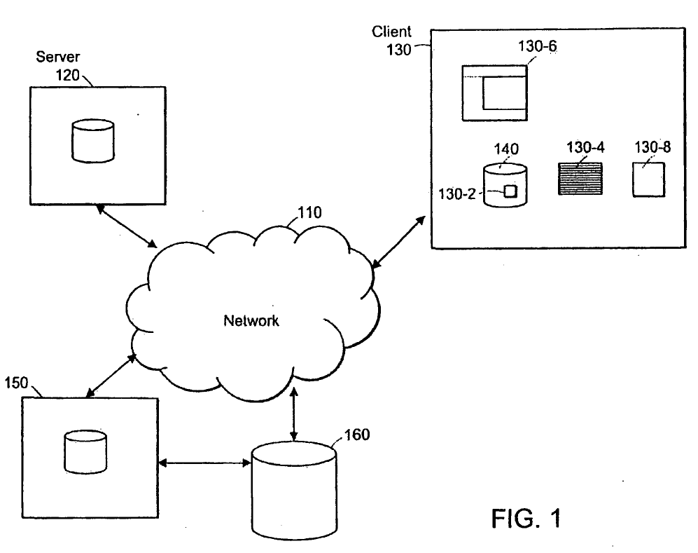

FIG. 1 is a block diagram of the computer system architecture according to an embodiment of the invention. An interactive presentation is distributed over a network 110. The interactive presentation enables management of both hardware and software components over the network 110 using Internet technology. The network 110 includes at least one server 120, and at least one client system 130. The client system 130 can connect to the network 110 with any type of network interface, such as a modem, network interface card (NIC), wireless connection, etc. The network 110 can be any type of network topology, such as Internet or Intranet.

According to a certain embodiment of the invention, the network 110 supports the World Wide Web (WWW), which is an Internet technology that is layered on top of the basic Transmission Control Protocol Internet Protocol (TCP/IP) services. The client system 130 supports TCP/IP. The client system 130 includes a web browser for accessing and displaying the interactive presentation. It is desired that the web browser support an Internet animation or video format, such as Flash™, Shockwave™, Windows Media™, Real Video™, QuickTime™, Eyewonder™, a mark-up language, such as any dialect of Standard Generalized Markup Language (SGML), and a scripting language, such as JavaScript, Jscript, ActionScript, VBSscript, Perl, etc. Internet animation and video formats include audiovisual data that can be presented via a web browser. Scripting languages include instructions interpreted by a web browser to perform certain functions, such as how to display data.

An e-learning content creation station 150 stores the interactive presentation on the server 120. The e-learning content creation station 150 includes content creation software 150 for developing interactive presentations over a distributed computer system. The e-learning content creation station 150 enables access to at least one database 160. The database 160 stores interactive presentation data objects such as text, sound, video, still and animated graphics, applets, interactive content, and templates.

The client system 130 accesses the interactive presentation stored in the database 160 or from the server 120 using TCP/IP and a universal resource locator (URL). The retrieved interactive presentation data is delivered to the client system 130. At least one data object of the interactive presentation is stored in a cache 130-2 or virtual memory 130-4 location on the client system 130.

The client system 130 may be operated by a student in an e-learning course. The e-learning course can relate to any subject matter, such as education, entertainment, or business. An interactive presentation is the learning environment or classroom component of the e-learning course. The interactive presentation can be a web site or a multimedia presentation.

Aspects of this invention are commercially available from Telecommunications Research Associates, LLC of St. Marys, Kans. and automatic e-Learning, LLC of St. Marys, Kans.

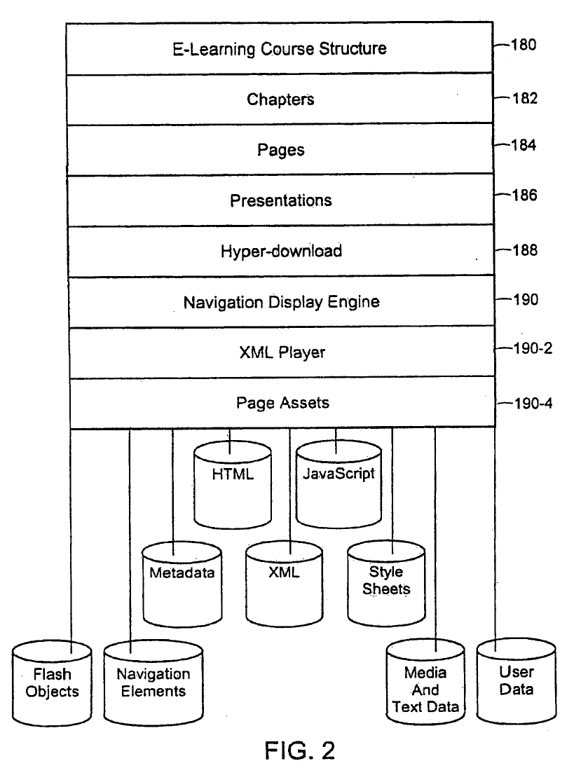

FIG. 2 is a schematic block diagram of some of the software components associated with the interactive presentation. The interactive presentation may include an e-learning course structure 180, which has chapters 182 with individual pages 184 and one or more interactive presentations 186. The interactive presentations 186 may include additional attributes or page assets 190-4, such as flash objects, style sheets, etc. Further components include a hyper-download system 188, a navigation engine 190, and an XML player 190-2. These components will be discussed in more detail below.

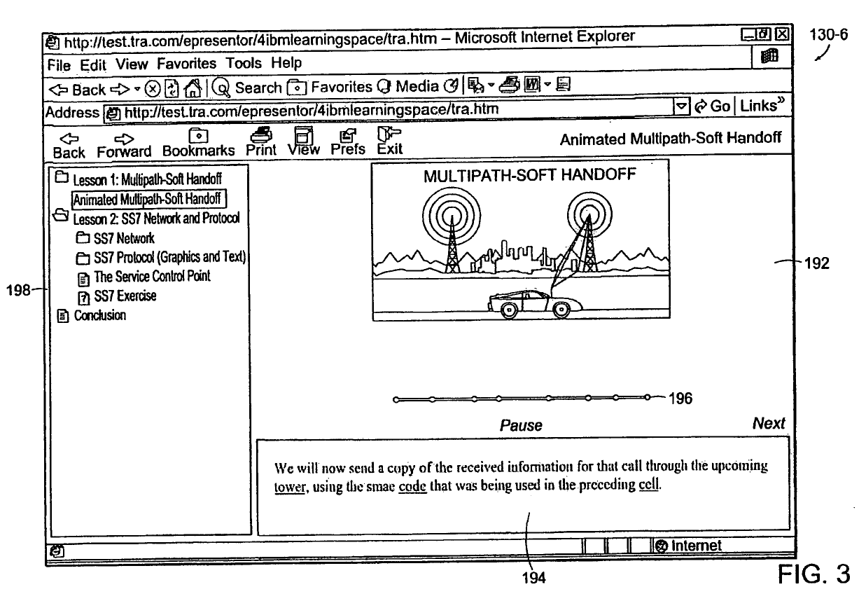

FIG. 3 is a depiction of an interactive presentation displayed in a browser user interface. As shown in FIG. 3, an interactive presentation is displayed in a browser user interface 130-6. In general, the layout of the user interface features four specific areas that display instructional, interactive or navigational content. These four areas are animation-video region 192, closed caption region 194, toolbar 196, and table of contents 198.

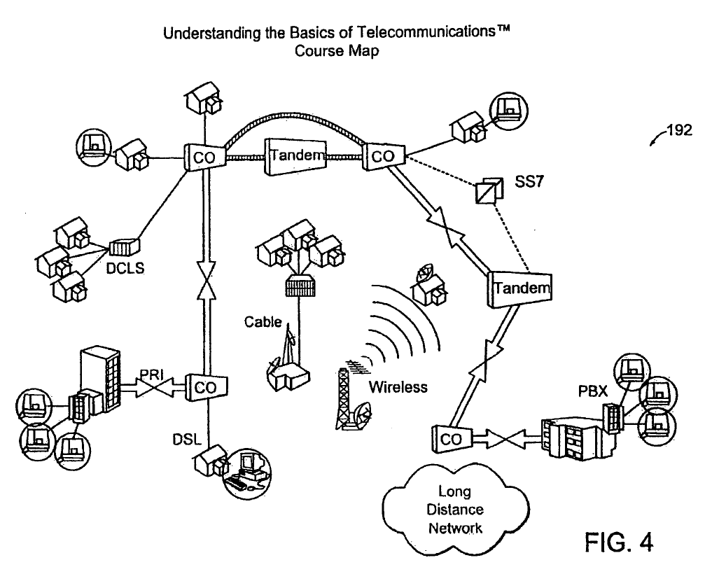

The animation-video region 192 displays media objects, such as Macromedia Shockwave™ objects, web-deliverable video, slide show graphics with synchronized sound, or static graphics with synchronized sound. FIG. 4 depicts an example of the animation-video region 192 of the user interface 130-6. In this example, the animation-video region 192 displays a course map. The course map provides an overall view of the course chapters and sections, and provides a navigational tool that allows students to navigate to a specific topic or section of a chapter or lesson within the course. The course map links to the course structure file, which defines the structure of the interactive presentation.

Technical content interface buttons can be used in connection with the course map. If selected, the buttons can perform navigation events. One example of an action performed in connection with a navigation event is to display a course introduction movie. If the course introduction movie is pre-loaded, it is displayed on the user interface 130-6 of FIG. 1. If the introduction movie is not pre-loaded, it is delivered from the server 120 via hyper-download and then displayed.

In addition to navigational tools, the animation-video region 192 shown in FIG. 3 can display interactions. An interaction handler causes the contents of an interaction to be displayed. The interaction handler can be written in ActionScript or JavaScript. The interaction handler may determine the content of an interaction based on a mode associated with the interaction. The mode can be defined by the attributes of the course structure file. In particular, the course structure file can instruct the interaction handler to display an interaction according to a specific mode, such as interaction mode, interaction with the check it button mode, quiz mode, and test mode. The mode defines the content displayed on the user interface and the navigation elements associated with the interaction. The mode also defines the testing environment for the interaction.

Interactions are desirable because they enhance the e-learning experience of the student. Interactions provide the instructor interactive component that is lacking in the conventional e-learning environment. Specifically, the interactions provide students with the opportunity to apply their knowledge and skills. Interactions also provide feedback to the students when the students answer, and allow students to compare their answers with the correct answer.

There are five general types of interactive e-learning interactions: dichotomous, multiple choice, multiple Select, matching, and ordered list.

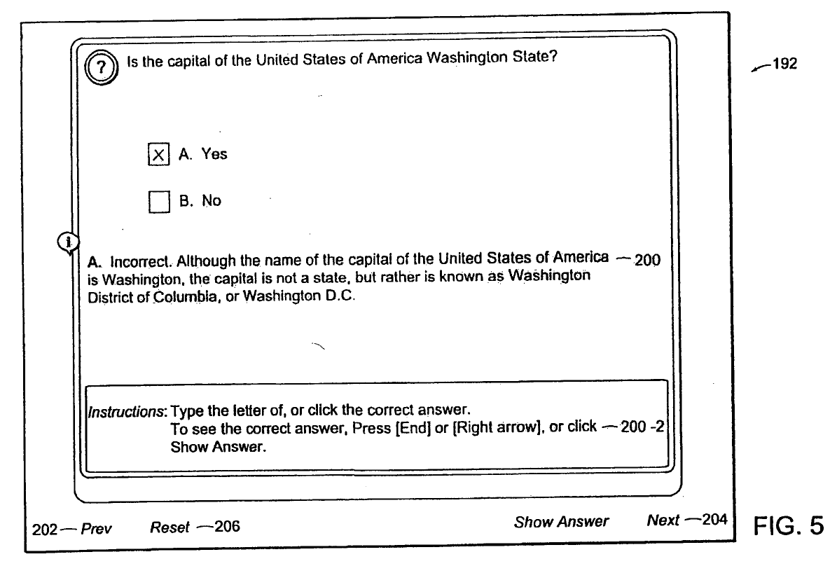

FIG. 5 is a depiction of a text based dichotomous interaction. The dichotomous interactive e-learning interaction is displayed in the animation-video region 192 of the user interface 130-6 of FIG. 3.

An interaction with a single question and exactly two answers is a dichotomous interaction. The answer options shown in FIG. 5 are A/B variables. The answers can be selected via mouse interaction or keystroke interaction.

Text accompanying the student's selection of an answer is feedback 200. Links to review relevant portions of the course are called remediation objects 200-2. A remediation object is displayed when an answer is selected. The remediation object 200-2 provides feedback to the user by displaying a link to additional information. Interactions can display navigation buttons that the user can select. A previous button 202 is displayed and scripted to load a previous page. A next button 204 is displayed and scripted to load a next page. A right arrow keystroke interaction performs the same function as the next button 204. The next button 204 and the right arrow keyboard command have a corresponding record number, which can be specified by remediation link. A reset button 206 is scripted to reset or clear a user's current answer or selection.

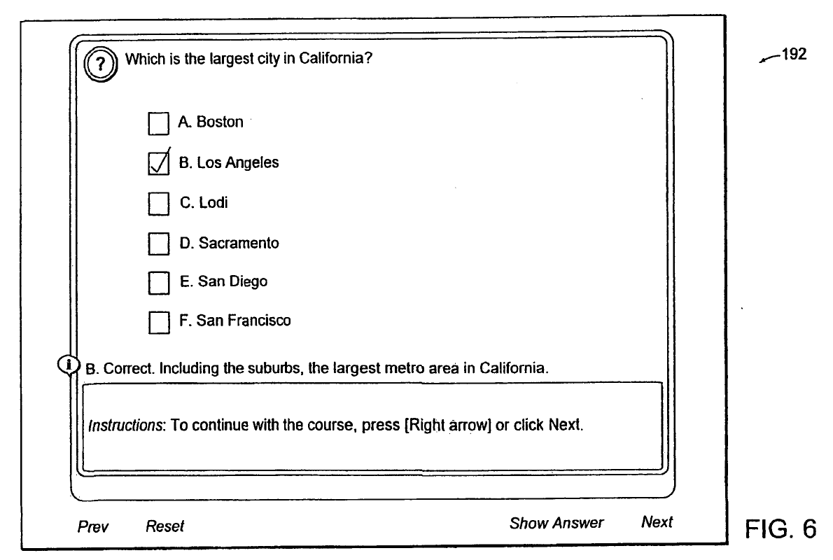

FIG. 6 is a depiction of a text based multiple choice interaction. The text based multiple choice interaction is displayed in the animation-video region 192 of the user interface 130-6 of FIG. 3. An interaction with a single question and several answers (only one of which is correct) is a multiple choice interaction.

The interactions can include graphical objects that the user can interact with.

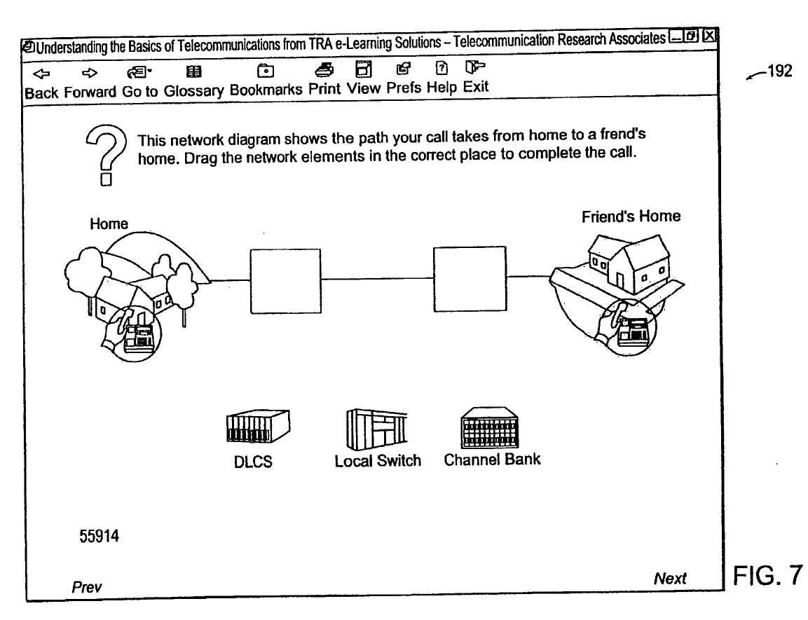

FIG. 7 is a depiction of a graphical multiple choice interaction. The graphical multiple choice interaction is displayed in the animation-video region 192 of the user interface 130-6 of FIG. 3. A graphical object can be part of the interaction, such as a draggable object. The graphical object can be included in the interaction as part of the user's interaction with the question or the answer.

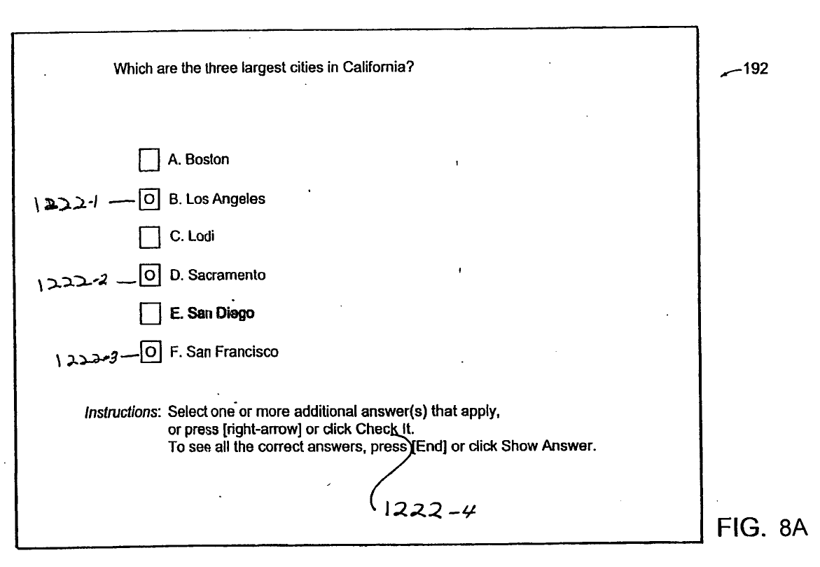

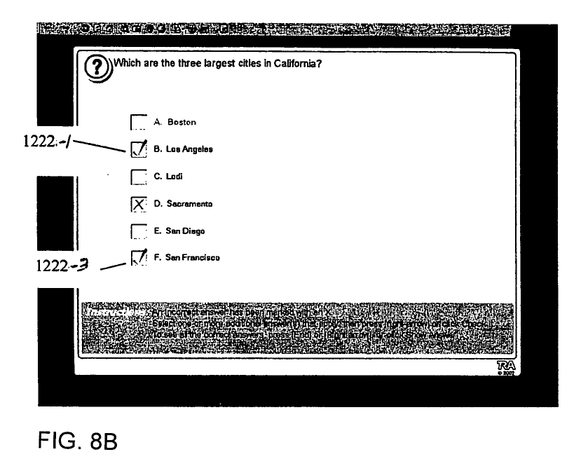

FIG. 8 is a depiction of a text based multiple select interactive e-learning interaction displayed in the animation-video region 192 of the user interface 130-6 of FIG. 3. An interaction with a single question and several answers (more than one of which is correct) is a multiple select interaction.

This multiple select interaction is in check it button mode, which displays a check it button 230-2. If selected, the check it button 230-2 can notify the user that their selection input is correct or incorrect. Specifically, the check it button 230-2 is scripted to display a correct answer. When the check answer button 230-2 is selected, the answer selected is graded and scored. This score is stored in a cookie identifier. The cookie identifier can be stored on the client system 130 of FIG. 3 or on the server 120 of FIG. 3. The server 120 can be a learning management system. The user can login to the learning management system. The learning management system allows students taking the e-learning course to login and experience the interactive presentation. The students can also store notes in their user data on the learning management system.

Each time the user makes a selection in one of the answer fields 230-4, the user's selection choice is stored in a cookie identifier even when the user does not select the check it button 230-2. For example, when the user selects an answer, the user's score is stored in a cookie identifier. The user does not need to input the answer with the check it button 230-2 for the user's score to be stored in the cookie identifier. The user selects the check it button 230-2 to determine if their answer is correct, and to receive feedback and remediation.

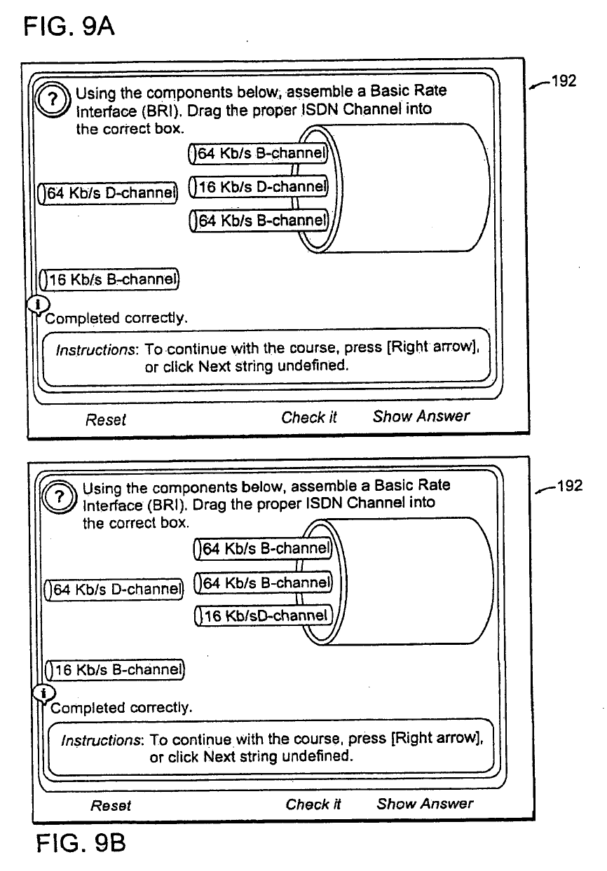

Matching interactions can be rendered in several different formats, such as drag and drop, label drag and drop, puzzle, puzzle, building block, or fill in the blank. FIGS. 9A-B are depictions of graphical drag and drop interactions. The drag and drop interaction is displayed as a sequence of interaction events to illustrate how the interface changes in response to a user dragging a graphical object and dropping it into a drop zone (hotspot). The drag and drop interaction allows the user to drag one graphical object at a time to the correct drop zone. The drag and drop interaction includes embedded code that identifies the drop zones and the hot spots in the interaction. The drop zones and hot spots specify particular coordinates on the graphic. Graphical coordinates can be used in multiple choice, multiple select and drag and drop interactions. A drag and drop interaction can be variations of the multiple select or matching interactions.

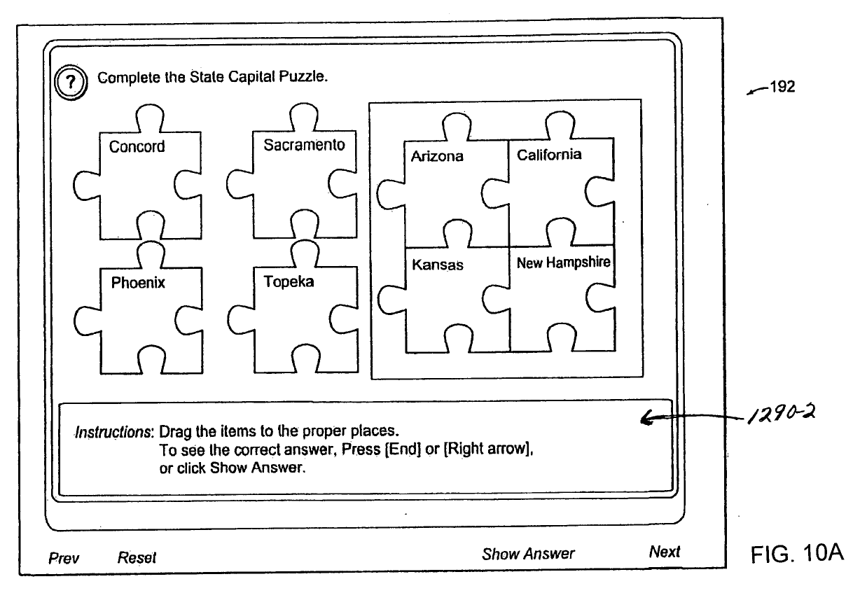

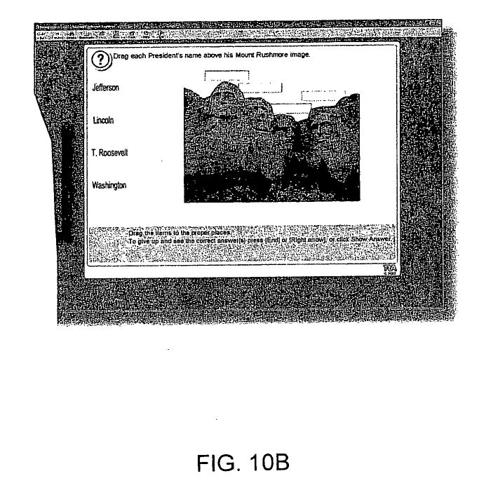

FIG. 10A is a depiction of a graphical puzzle interaction. FIG. 10B is a depiction of a label matching interaction. Similar to a drag and drop interaction, the puzzle interaction and label matching interaction provide multiple questions that must be matched to one or more answers.

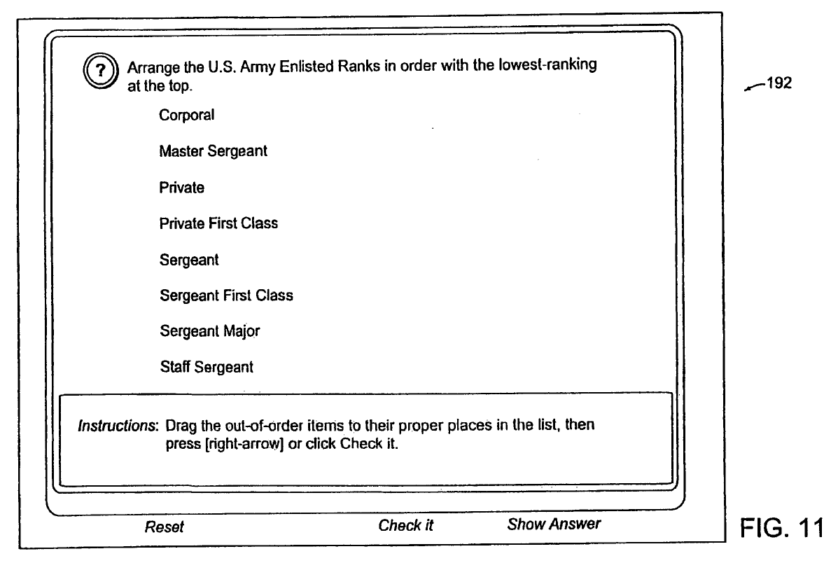

FIG. 11 is a depiction of a graphical ordered list interaction. Ordered list interactions present the student with a list of items that are to be placed a specified order.

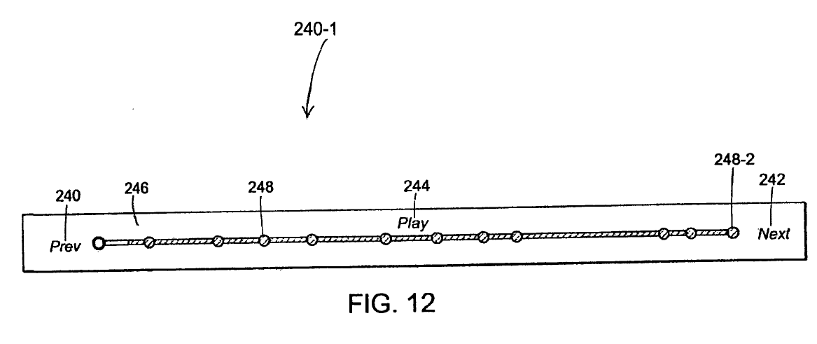

FIG. 12 is a depiction of a course navigation bar. The course navigation bar 240-1, for example, may be displayed in the toolbar region 196 of the user interface 130-6 of FIG. 3. The course navigation bar 240-1 provides navigation/playback control buttons. The user can navigate through sections of the interactive presentation by using the navigation/playback control interface buttons displayed with the course navigation bar. The navigation/playback control interface buttons include control elements such as a previous button 240, next button 242, pause/play button 244, and a progress bar 246.

If the navigation/playback interface button is selected, it can initiate navigation events.

The progress bar 246 displays three types of information to the user. The amount of the page delivered to the client system is displayed. The current page location within course structure file, and the number of time-markers 248 present in the course page are also displayed.

Each time-marker 248 is a node or frame in the interactive presentation time-line. The time-markers 248 can be used to navigate to specific frames in the interactive presentation. A user can use a mouse interaction or keystroke interaction to navigate the interactive presentation time-line using the time-markers 248. Mouse and keystroke interactions can be coded with scripting languages. Interface buttons can be created in Flash or dynamic hypertext markup language (DHTML). Mouse and keystroke interactions can be interpreted by a browser or processed with an ActiveX controller.

When navigating with the time-markers 248, the synchronization of animation-video region 192, closed caption region 194, toolbar 196 and table of contents 198 of FIG. 3 can be preserved. For example, when the user initiates a navigation event by using a keystroke interaction, such as the right arrow key, the navigation display engine can navigate to a specific frame within the interactive presentation time-line, and display text, animation and audio assets associated with the frame in synchronization. In particular, the time-markers 248 preserve this synchronization.

If a user initiates a navigation event to advance to the next time-marker 248-2 and the progress bar indicates that the current time-marker 248 is the last in the time-line, the navigation display engine can display the next page in the chapter from the cache location 130-2 of FIG. 1. If the next page is not stored in the cache location 130-2 of FIG. 1, the hyper-download system delivers the page. When the next page is accessible from the client system 130, the audio-visual contents of the next page are played-back in the animation-video region 192, the closed caption region 194, the toolbar 196 and the table of contents 198 of FIG. 3 in synchronization. Specifically, a function is called that retrieves the next text element of the closed caption region from an array and writes that text element. By storing the text elements of the closed caption region in an array, the navigation display engine can display the text in the closed caption region in synchronization with the contents of the next page, and thus, preserve the viewing experience for the user.

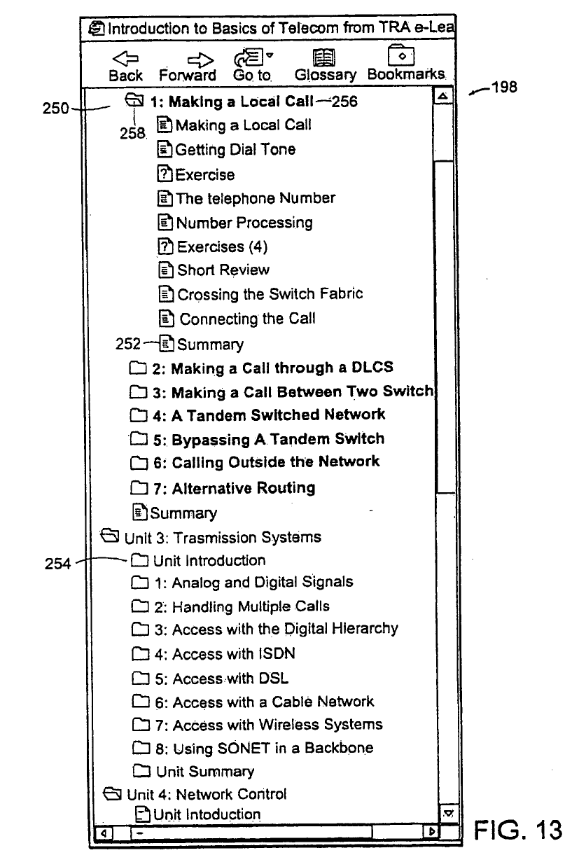

FIG. 13 is a depiction of the table of contents 198 of the user interface 130-6 of FIG. 3. The table of contents 198 is a navigation tool that dynamically displays the course structure in a vertical hierarchy providing a high-level and detailed view. The table of contents 198 enables the user to navigate to any given page of the interactive presentation. The table of contents 198 uses the course structure file to determine the structure of the interactive presentation. The user can navigate the table of contents 198 via mouse interaction or keystroke interaction.

The table of contents 198 is a control structure that can be designed in any web medium, such as an ActiveX object, a markup language, JavaScript, or Flash. The table of contents 198 is composed of a series of data items arranged in a hierarchical structure. The data items can be nodes, elements, attributes, and fields. The table of contents 198 maintains the data items in a node array. The node array can be an attribute array. The table of contents 198 maps its data items to a linked list. The data items of the table of contents 198 are organized by folders 250 (chapters, units or sections) and pages 252. Specifically, the folders 250 and pages 252 are data items of the table of contents 198 that are stored in the node array.

Each folder 250 is a node in the node array. Each folder 250 has a corresponding set of attributes such as supporting folders 254 and pages 252, a folder title 256, folder indicators 258, and XML and meta tags associated with the folder. The folder indicators 258 can indicate the state of the folder 250. For example, an open folder can have an icon indicator identifying the state of the open folder. The XML and meta tags can be used to differentiate instances of types of content and attributes of the folders 250.

Each page 252 is a supporting structure of a folder 250. Each page 252 has a corresponding set of attributes such as supporting child pages, an icon that shows the page type, a page title, and any tags associated with the contents of the page 252. The pages 252 have page assets that can be tagged with XML and meta tags. The tags define information from the page assets.

When the user selects a folder 250 within the table of contents 198, the navigation display engine toggles between an open state and a closed state. Specifically, the table of contents 198 either exposes or hides some of the attributes of the selected folder.

When the user selects a specific page 252 (via mouse click interaction or keystroke interaction) from the table of contents 198, the browser displays the current page. The state of the current page 252 (such as the topic title 256) is displayed as subdued on the user interface 130-6 of FIG. 3, and an icon appears indicating the state of the page 252. The state 252 of the page indicates whether the page has been visited by the user.

The state of the page is maintained even if the client system 130 disconnects and reconnects to the network 110 of FIG. 1. This accommodates students in an e-learning course that are prone to periodically connect and disconnect to the interactive presentation on the network. The state of the page is determined by a cookie identifier. For example, the state of the page can be determined by processing the user data for a cookie identifier stored in cache 130-6 or memory 130-4.

The table of contents 198 may include a lookup table, a hash table, and a linked list. The table of contents 198 maps its data items, such as its nodes and attributes 250, to the linked list. The data items are searchable and linked by the linked list. The table of contents 198 data items can be searchable via a search engine or portal. The search can locate and catalog the data items of the table of contents. When a search query is entered, the search produces a search result (if one exists) linking the data item. In another embodiment, the XML and meta tags from the folders and pages are used to search for particular instances of content and attributes of the individual folders 250 and pages 252.

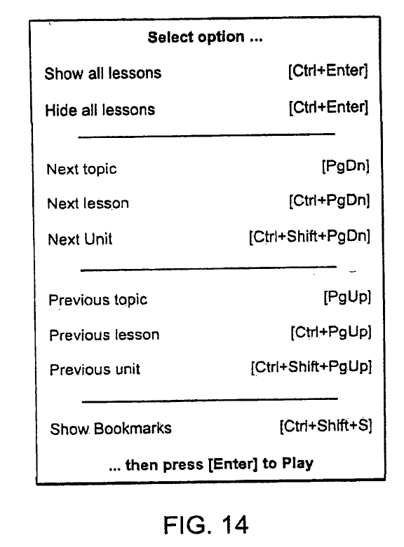

FIG. 14 is a depiction of an aspect of the table of contents shown in FIG. 3. The table of contents offers an additional navigational menu that can be accessed via a right click mouse interaction or keystroke interaction. The diagram displays the right click menu options.

In general, mouse and keystroke interactions can enhance the user's viewing and learning experiences. Specifically, the mouse and keystroke navigational features of the interactive presentation are designed to be versatile, and user friendly. Typically, e-learning presentations do not provide both versatile and user friendly navigation designs. For example, conventional e-learning web sites do not utilize dual navigation features, such as a mouse interaction and keystroke interaction that perform the same task.

The interactive presentation includes dual navigation controls that perform the same task. A user can control elements of the interactive presentation via interface buttons and associated keystroke commands. Each button calls associated functions that instruct the interactive presentation to display specific course elements. Each button can have a corresponding keystroke interaction.

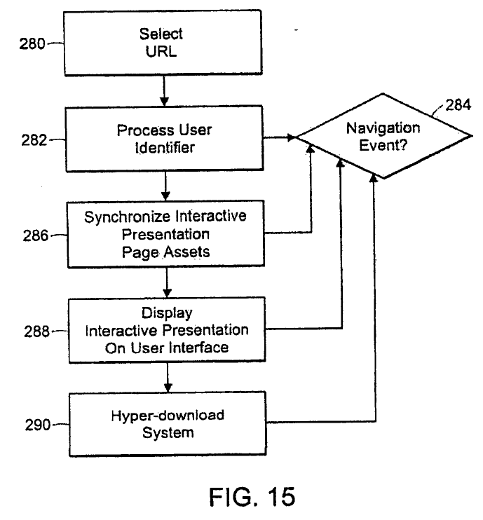

FIG. 15 is a flow diagram depicting user interaction with the interactive presentation. At 280, the user selects a URL in connection with the interactive presentation. At 282, the navigation display engine determines the user's status by processing the user data for an identifier.

The navigation engine can also determine the user's status based on a user login to the server 120 of FIG. 1. For example, when the server 120 is the learning management system (LMS), a user can enter a user name and password to access the interactive presentation. The login data is passed to the interactive presentation.

The login data and identifiers associated with a user's status are described as user data. The user data can define the interface and contents of the interactive presentation associated with a particular user. The user data can indicate the user's navigation history, and the user's scores on interactions. In particular, the user data enables the interactive presentation to track the user's actions.

The user data can be associated with navigation or cookie files. Navigation and cookie files can indicate the navigation history of the user. For example, a user that has previously visited the interactive presentation can have a cookie identifier stored on the client system 130 or on the server 120 (LMS). If the navigation display engine determines that the user is a returning student, the navigation display engine provides the student with links to pages that the student accessed at the end of their previous session. The links are determined based on the student's status defined in their user data.

In certain circumstances, the navigation display engine dynamically disables or enables the user navigation controls based on the student's user data. For example, if the user data indicates that a student does not meet the prerequisites for the course, the navigation display engine can disable certain options for that user.

The navigation display engine is always monitoring the user's actions to detect navigation events. The navigation events can be triggered by the actions of the user in connection with an interaction. A user can initiate a navigation event with a mouse interaction or a keystroke interaction. Navigation events can also be triggered by the navigation elements in the page assets.

When a user initiates a mouse interaction in an interaction, typically, a navigation event object can be sent to the navigation display engine. The navigation event object allows the navigation display engine to query the mouse position in both relative and screen coordinates. These values can be used to ascertain a navigation event object transformation between relative coordinates and screen coordinates. With these values the navigation display engine can respond accordingly to the user's interaction.

For example, if the user is selects an answer for an interaction such as a multiple select, the user data is updated to score the user's selection. The user's selection is scored even when the user does not select the check it button to input the answer. Specifically, the navigation display engine is monitoring the student's interaction, and stores a value in the user data that represents the user's current selection. If the user decides to make a different selection, and inputs a new selection, the value in the user data is updated.

If the navigation display engine detects a navigation event, the navigation display engine proceeds to 284. At 284, the navigation display engine processes the navigation event, and then returns to 284.

If a navigation event is not detected, then the navigation display engine synchronizes interactive presentation page assets at 286. The navigation display engine synchronizes the page assets according to the state of the page and the user data. For example, the navigation display engine synchronizes the table of contents to reflect a selection of a page and folder. If a user accesses a new page, and thus, initiates a navigation event, the navigation event is processed at 284.

If the user does not initiate a navigation event, the page is displayed on the user interface at 288. The navigation display engine processes the page into a form that the browser requires.

If a user initiates a navigation event, the navigation event is processed at 284. If a navigation event is detected, the hyper-download system pauses and returns to 284. If the user does not initiate a navigation event, the hyper-download system process begins at 290.

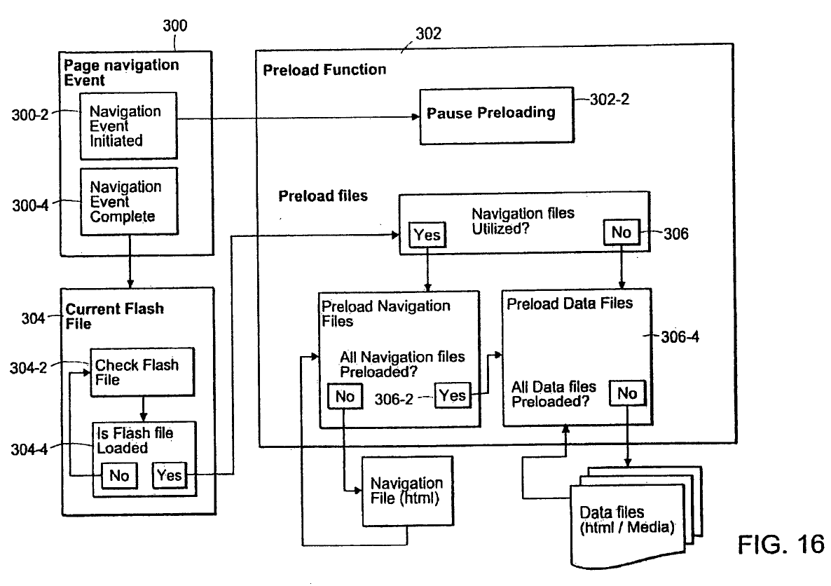

FIG. 16 is a flow diagram depicting the hyper-download process. The hyper-download system enables the pre-loading engine to accelerate the delivery of interactive presentation data to the client system. By way of background, when a page on a network (such as a web page) is selected by a user for viewing, the user typically waits for the page assets to be delivered and views the page. In general, a media element of the page is delivered, and displayed. As a result, the page assets are not displayed on the client system at the same time. This arrangement causes problems for pages that include synchronized animation and scrolling text (for closed captioning).

Moreover, this arrangement causes problems for e-learning interactive presentations that have chapters or sections with more than one page displaying high volume text and media data. For example, when a user is viewing a page in a chapter, and selects the next page, the user must wait for the next page to be delivered to the client system until the user can view the page. As a result, the user experiences a delay in viewing the next page's assets. In an e-learning environment, this delay in viewing consecutive pages disrupts the user's viewing and learning experience.

Different schemes have been developed to preserve the viewing experience of media over a network connection. One scheme combines the entire course content (animation, video, audio, page links, text, etc.) into a single media object. For example, Flash™, Windows Media™, Real Video™, and QuickTime™ formats can be used to combine several different types of media assets into a single file. In some situations, by combining the text and animation media assets of page content into one single file or media object, the synchronization of the media assets can be preserved when delivered to the client system. However, the preservation and effectiveness of the user's viewing experience depends on a number of factors including the method of delivery to the client system, the network bandwidth, and the volume of the presentation, such as whether it has extensive linking to other pages.

There are various approaches to delivering the media object to the client system. In general, the media object can be delivered by download, progressive download (pseudo-streaming), or media stream. A media object for download can be viewed by the user once it is stored on the client system. Progressive download allows a portion of the media object to be viewed by the user while the download of the media object is still in progress.

A media object can be sent to the client system and viewed by the user via media stream. A streaming media file is streamed from a server and is not cached on the client system. Streaming media files should be received in a timely manner in order to provide continuous playback for the user. Typically, streaming media files are neither optimized for users with low bandwidth network connections nor high bandwidth network connections that suffer from sporadic performance. High bandwidth network connections can become congested and cause network delay variations that result in jitter. In the presence of network delay variations, a streaming media application cannot provide continuous playback without buffering the media stream.

Media streams are generally buffered on the client system to preserve the linear progression of sequential timed data at the user's end. Consecutive data packets are sent to the client system to buffer the media stream. Each packet is a group of bits of a predetermined size (such as 8 kilobytes) that are delivered to a computer in one discrete data package. In general, the data packets are to be displayed the instant they are received by the user's computer. The media stream, however, is buffered and this results in a delay for the user (depending on the user network's connection). As a result, the end-to-end latency and real-time responsiveness can be compromised for users with low bandwidth network connections or high bandwidth network connections suffering from sporadic performance.

Moreover, streaming media applications are not very useful for multi-megabyte interactive presentation data. For example, when a student connects to a media stream, the contents are not cached, and therefore, the student cannot disconnect and reconnect again without disrupting their e-learning experience. Specifically, to reconnect, the student must wait to establish a connection with the server, and wait for contents to buffer before the student can actually view the e-learning content via media stream. Furthermore, a multi-megabyte course delivered via media stream can be difficult for the student to interact with and navigate through because the contents are not cached, and therefore, the student can experience a delay while interacting with the media stream.

Prior schemes can preserve the viewing experience of single low volume media objects over a high volume bandwidth network connection, such as a local area network (LAN) connection that does not suffer from sporadic performance. But, these schemes are neither suitable for multi-megabyte nor for presentations that include interactive media. In particular, they are not suitable for e-learning environments that include several pages with multi-megabyte, interactive content because the user experiences a delay in viewing linked pages.

For example, consider an e-learning course distributed over a network. The course includes chapters, and each chapter includes more than one page—each displaying high volume media objects, and providing a link to the next page. When a user selects a link to the next page or previous page in a chapter, there can be a delay before the user is able to actually view the page. Specifically, the user must wait until the media objects on the page are downloaded (unless the page is in the users's cache) or streamed before actually viewing the page in its intended form. As a result, there can be interruptions in the user's viewing experience and interactive experience. These interruptions are common to viewing such material over low and high bandwidth network connections.

According to an embodiment of the present invention, a hyper-download system 300 delivers interactive presentation data to a client system 130 in an accelerated manner without the standard interruptions common to viewing such material over a low and high bandwidth network connections. The pre-loading engine 302 systematically downloads pages of the interactive presentation. The pre-loading engine delivers the interactive presentation data to a scratch area, such as a cache 130-2 location on the client system 130.

The cache 130-2 location is typically a cache folder on a disk storage device. For example, the cache 130-2 location can be the temporary Internet files location for an Internet browser. The cache 130-2 size for the Internet browser can be determined by the user with a preference setting. As the page assets are delivered, a conventional browser can dynamically size its cache to the amount of course content delivered from the server 120 for the length of the user's e-learning session.

In one embodiment, the pre-loading engine 302 delivers the assets of anticipated pages to the cache 240-1 sequentially based on the user's navigation history. The pre-loading engine anticipates the actions or navigation events of the user based on navigation and cookies files.

In another embodiment, the pre-loading engine 302 downloads pages to the cache sequentially from the course structure file based on the chapter and page numbers. In particular, the content section of the course structure file defines the logical structure of pages for the pre-loading engine to deliver. For example, when a user accesses a particular course section or course page number, the pre-loading engine delivers the page assets of the logical subsequent page, and logical previous page. However, this change is in response to user navigation. In the event that the user deviates from the sequential order of the course before the page has been downloaded, the pre-loading engine 302 aborts the download of the current page, calls the selected page from the central server 120, and begins downloading the selected page assets.

For example, a user selects a page from the table of contents. If the assets for that current page are cached, the page is displayed from the user's cached copy and the pre-loading engine delivers the assets of the next sequential page. If the assets for that current page have not been downloaded, assets are then delivered from the central server 120. Once a sufficient percentage of the current page's assets are displayed, playback begins of the partially downloaded page. After all of the current page assets are loaded, pre-loading resumes delivery on pages that the hyper-download system anticipates the user is going to access in future navigation events.

By pre-loading anticipated pages, the browser can display multi-megabyte course content files without the standard interruptions common to viewing such content over low and high bandwidth network connections. Specifically, the anticipated pages are accessible from the client system and can be displayed without having to be delivered when a user navigates to these pages.

Pre-loading is initiated following a navigation event 300-2 and is paused during the loading of the page 302-2. While page assets are delivered, a watcher program monitors the progress of the delivery of any Flash files (or any media content) associated with the page. The pre-loading engine ensures that the current page is completely loaded before pre-loading resumes delivery of the anticipated page.

The hyper-download system determines whether there are navigation files in the page assets 306 of an anticipated page. In conventional browsers, navigation files can increase page navigation performance. Navigation files can instruct the browser how to display and navigate the HTML content. If the hyper-download system determines that navigation files are used, the navigation files are delivered 306-4 to the client system 130. After the navigation files are delivered to the client system 130, the pre-loading engine delivers the remaining page assets 306-4 to the client system 130.

The pre-loading engine can include a limiter. The limiter can limit the number of pages ahead of the current page in the course structure file that the pre-loading engine delivers to the client system.

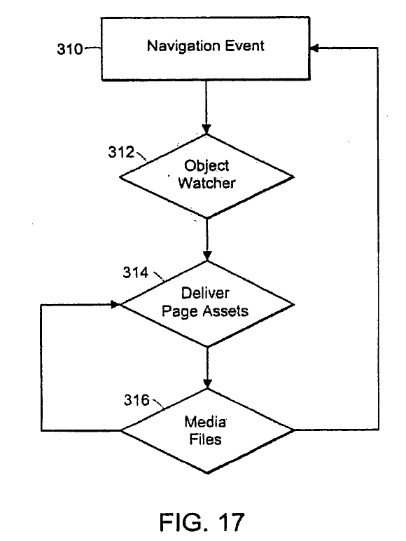

FIG. 17 is a flow diagram depicting an aspect of the hyper-download system. At 310, a navigation event initializes the hyper-download process, and delivers the page that the user selected.

At 312, an object watcher ensures or certifies that specific media objects included in the current page assets are delivered to the cache location. In particular, the object watcher certifies the completion of delivery of flash objects or shockwave objects that are included in the assets of the current page.

Once the object watcher certifies that delivery is complete, the hyper-download system proceeds to 314. At 314, the pre-loading engine delivers specific page assets of an anticipated page. The pre-loading engine determines a priority scheme for priority delivery of certain page assets of the anticipated page. The priority scheme is determined based on content type.

According to one embodiment of the invention, the pre-loading engine delivers XML, JavaScript and HTML page assets before delivering any other page asset. The XML, JavaScript and HTML page assets are delivered to a memory location or a cache location. For example, when an anticipated page includes XML page assets, the pre-loading engine can deliver the XML page assets before delivering any other types page assets.

Storing XML, JavaScript and HTML page assets to the memory location 130-4 enables the navigation display engine to display the anticipated page without unnecessary delays. Storing XML, JavaScript and HTML page assets to the cache location 130-2 provides an alternate mechanism for accessing the script, and therefore, increases the overall stability of the hyper-download system. For example, the delivered XML page assets cause the hyper-download system to replace any XML reference links in the current page of the course structure file.

The XML data for each page supplies a list of the assets (reference links) to be downloaded for each page. The XML tag reference links in the current page of the course structure file are replaced with the actual XML data of an anticipated page. The reference links are similar to location pointers that link to information that can be drawn from other files.

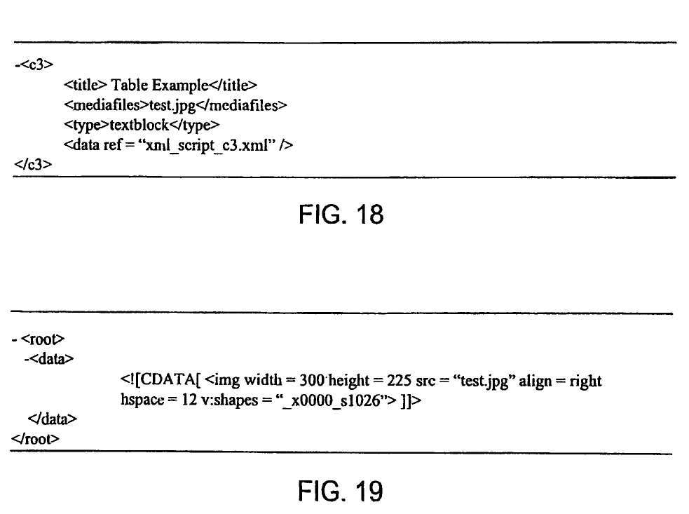

According to an embodiment of the present invention, the pre-loading engine gives a first priority status to specifically to XML data in an anticipated page. For example, the course structure file includes reference links to XML data of an anticipated page. The hyper-download system replaces the XML data reference links in the course structure file with the corresponding XML data of the anticipated page. FIG. 18 is a depiction of an example XML data reference link in the course structure file. For illustrative purposes only, a diagram depicting an XML data reference link in the course structure file is shown in FIG. 18, it is understood that the XML data provided are examples only and the XML can be scripted in any manner depending upon the particular implementation.

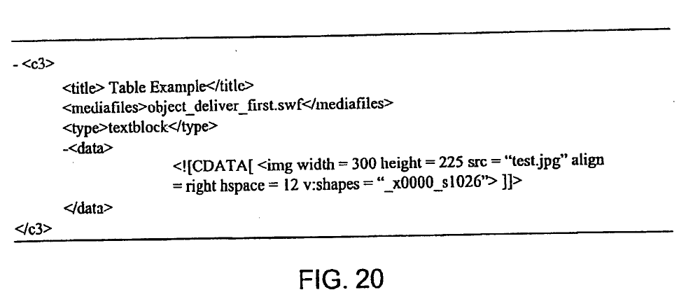

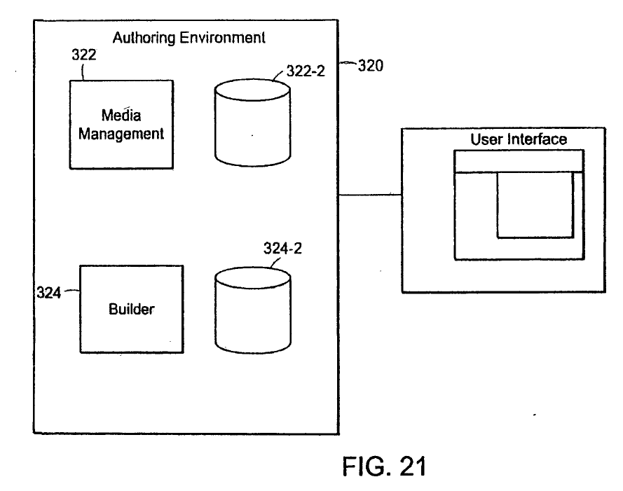

The course structure file includes an XML reference link that reads <data ref “XML_script_c3.XML”/>. The XML reference link is replaced in the client system memory with corresponding XML data of the anticipated page. FIG. 19 is a depiction of an example of XML data associated with an anticipated page. In particular, FIG. 19 shows the corresponding XML data of the anticipated page that replaces the XML reference link in the course structure file. FIG. 20 depicts the resulting XML data in the course structure file. Specifically, FIG. 20 shows the XML data in the course structure file after it is replaced with the actual XML data of the anticipated page.

By only including XML data references to other pages, the pre-loading system preserves client system resources. Specifically, the amount of XML data in the course structure file is reduced because only aliases are included that reference XML data of anticipated pages.

Once the XML data of the anticipated page are downloaded to client system, the pre-loading engine downloads the remaining assets for the anticipated page. The remaining page assets receive a secondary priority status for delivery.

In another embodiment, the pre-loading engine gives a first priority delivery status specifically to HTML data of anticipated pages. Specifically, HTML data are delivered before any other page asset in the anticipated page. Specifically, a reference in the course structure file to the HTML data of the anticipated page is replaced with the actual HTML data of the anticipated page. By only including HTML references or aliases in the course structure file, the pre-loading system preserves client system resources.

Once the HTML data of the anticipated page are downloaded to client system, the pre-loading engine downloads the remaining assets for the anticipated page. The remaining page assets receive a secondary priority status for delivery.

In another embodiment, the pre-loading engine gives a first priority status specifically to JavaScript data of an anticipated page. Specifically, JavaScript data page assets are delivered before any other page asset in the anticipated page. The pre-loading engine delivers JavaScript to the corresponding JavaScript location in the course structure file. Specifically, the anticipated page JavaScript script location in the course structure file is replaced with the actual JavaScript script in the anticipated page in the client system memory 130-4 or the client system cache 130-2.

Once the JavaScript data of the anticipated page are downloaded to client system, the pre-loading engine downloads the remaining assets for the anticipated page. The remaining page assets receive a secondary priority status for delivery.

At 316, the pre-loading engine delivers any remaining media assets of the anticipated page to the client system 130. Examples of remaining media assets are still images, sound files, video files, Applets, etc. The pre-loading system delivers the media assets to the user cache location 130-2.

When the pre-loading engine completes delivery of the media files, the hyper-download system returns to 316 and delivers the priority content of the next anticipated page. Specifically, this cycle continues until a navigation event is detected or until the assets of a certain number of anticipated pages are pre-loaded in the client system 130. Due to constraints on the client system resources (such as memory) the pre-loading engine can pause when it determines that a sufficient number of pages have been delivered.

By utilizing the pre-loading of particular page assets, the hyper-download system discourages the client system from experiencing a delay when viewing anticipated pages. For example, if the user navigates to a page that is pre-loaded, the navigation display engine can display the page without having to wait for the page to be delivered. Thus, the user viewing and learning experience of the interactive presentation can be preserved without unnecessary interruptions and delays.

In addition, XML, JavaScript or HTML data associated with page assets that have been delivered to the client system cache can be removed from the course structure file stored in memory. In particular, since the page assets have already been delivered to the client system, the pre-loading engine can remove their references from the course structure file to prevent the pre-loading engine from attempting to deliver those page assets to the client system again.

FIG. 21 is a block diagram of the system architecture used to create an interactive presentation according to an embodiment of the invention. An authoring environment 200 allows the interactive presentation to be developed on a distributed system. The authoring environment can create an interactive presentation product, and in particular, an e-learning product. The e-learning product can be used to create an e-learning course.

The authoring environment 320 includes a media management module 322 and a builder module 324. The media management module 322 and builder module 324 include logic for authoring an interactive presentation. The modules can be applications, engines, mechanisms, or tools. The media management module can create and manage a back-end database 322-2. The builder module 324 can create and manage a back-end database 324-2. It should be understood, however, that the authoring environment 320 can have any number of modules and databases.

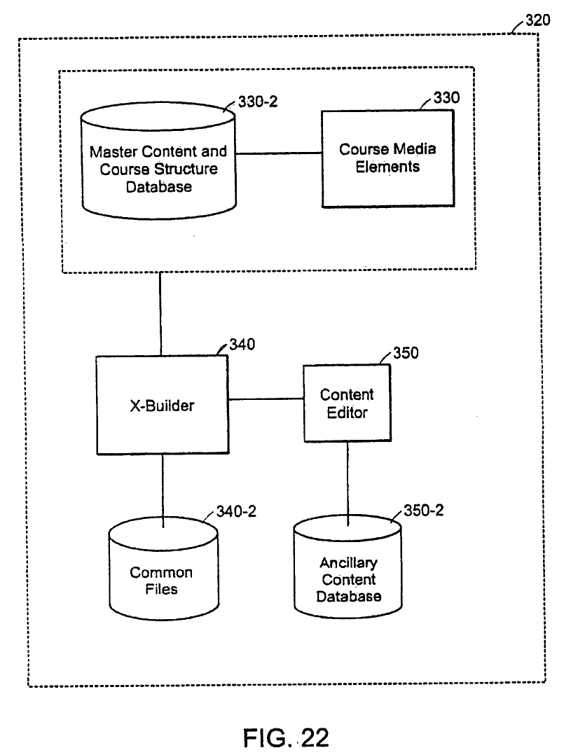

FIG. 22 is a block diagram of an authoring environment according to an embodiment of FIG. 21. The authoring environment provides a course media element (CME) application 330 and an x-builder application 340. The CME application 330 manages a master content course structure database 330-2. An x-builder application 340 manages a common files database 330-2. and an ancillary 350-2 content database.

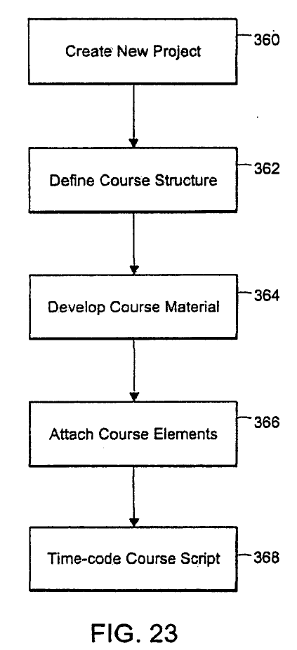

The CME application 330 develops and stores a new course project. FIG. 23 is a flow diagram depicting the steps of the CME application. At 362, the CME application 330 creates a new course project for an interactive presentation. At 362, the CME application 330 defines a course structure for the interactive presentation. The course structure is organized in a hierarchical arrangement of course content. For example, the CME application 330 can provide a hierarchical arrangement using a table of contents structure. The table of contents structure can be organized by chapters, and the chapters can include pages.

At 364, the CME application 330 provides course material for the course project. The CME application 330 stores individual pages with page assets in a master content library. At 366, the CME application 330 attaches the applicable page assets to each page in the e-learning course structure. At 368, time code information is inserted in the course script. The time code information synchronizes the media elements and the closed captioning text of the interactive presentation. For example, if the interactive presentation contains synchronized closed captioning text and animation, the closed captioning text is displayed on the user interface in synchronization with the animation. If the interactive presentation contains closed captioning text and audio, the closed captioning text is displayed in synchronization with the audio.

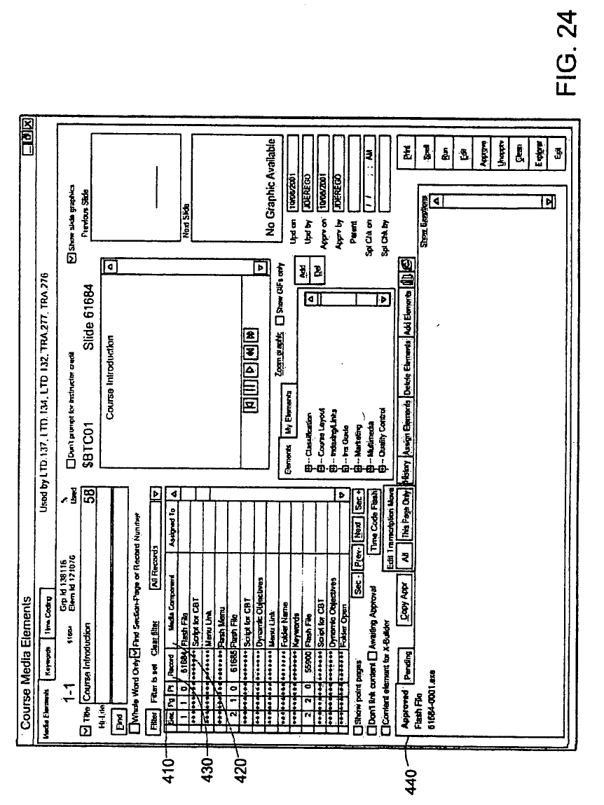

FIG. 24 is a depiction of the interface of the CME application 330. The page assets of each page are displayed on the CME application 330 interface. The page column 410 indicates the number of a page in the chapter. The media component column 420 identifies the page assets that are included in a particular page. The CME application 330 creates a new record number 430 for each page asset and approves 440 the page asset.

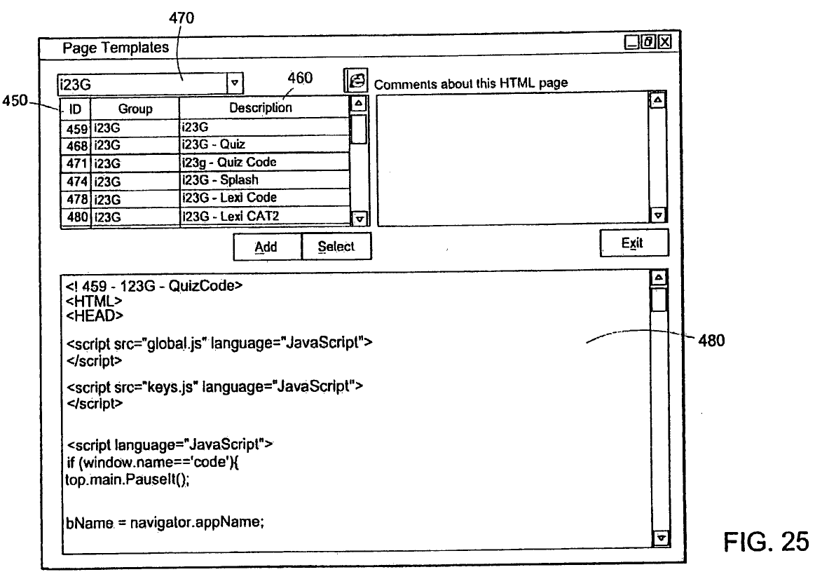

FIG. 25 is a depiction of the template manager interface of an embodiment of the CME application 330. A page template manager interface is shown. The CME application 330 can define certain actions for the x-builder application 340 to perform using the page template manager. For example, customized templates can be created that can over-ride the x-builder application's 340 default templates. Specifically, the customized templates instruct the x-builder application 340 to replace specific predefined variables in the default templates. The customized templates enable the CME application 330 to modify a template used in an interactive presentation.

A template record identification number 450 is assigned to each template. Each template can have a description 460 and can be assigned to a specific group 470 associated with a class of media elements. The template manager interface displays the code 480 for the template.

A template can be a HTML or XML document. The document can define a particular look and feel for one or more pages of the interactive presentation. The HTML file can include XML, JavaScript, and ActionScript. The look and feel can include navigation features, and presentation features, such as co-branding, colors, interface buttons, icons, toolbar arrangement, and font size, font color, and font types. For example, a template can include a style sheet that defines the features of an e-learning course.

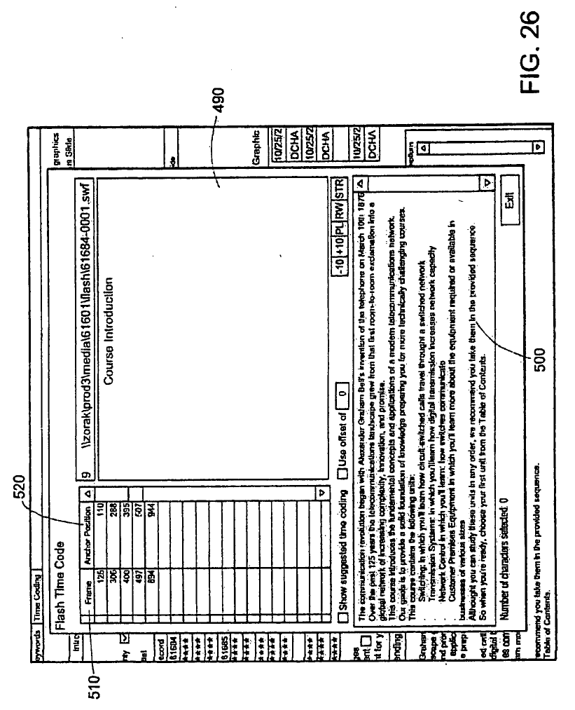

FIG. 26 is a depiction of the time-coder interface of the CME application 330. The time-coder displays the animation/video region 490 and the closed captioning region 500 of the interactive presentation interface.

The time-coder can be used to synchronize particular frames of the interactive presentation that include closed captioning text. A course developer can indicate a time code for a particular frame by placing a cursor on the character position of the closed captioning text when the desired frame of the animation/video region 490 is displayed in on the time-coder interface. The time-coder time-stamps the frame by determining the frame number 510 and anchor position 520. The anchor position 520 corresponds to the cursor position on the closed captioning text. Specifically, the anchor position 520 identifies the character position of the text at the frame number 510. With the frame number 510 and the anchor position 520, the time-coder synchronizes the text 510 and animation of an interactive presentation. When the time coding information has been inserted, the time coding information for the course project can be imported into the x-builder application 350-2.

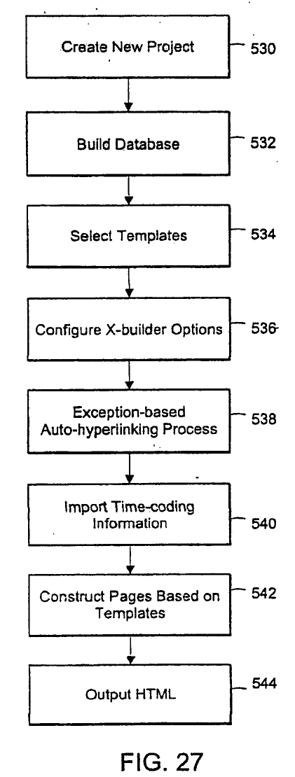

The x-builder application compiles the course project into the interactive presentation. FIG. 27 is a flow diagram depicting the steps of the x-builder application. At 530, the x-builder application 340 creates a new interactive presentation project.

At 532, the x-builder application 340 imports the course project from the 330-2 content and course structure database 330-2 to the common files database 330-2. The x-builder application imports content from other modules in the authoring environment. For example, the x-builder application 340 can import content from the ancillary content database 350-2.

The x-builder application content editor 350 manages the content stored in the ancillary content database 350-2. The x-builder application content editor 350 is a component application of the x-builder application 340. The ancillary content database 350-2 stores reference content such as templates, glossary assets, definitions, hyperlinks to web sites, product information, and keywords. For example, the reference content can include definitions for technology keywords in an e-learning course with technology subject matter. The x-builder content editor 350 maintains the integrity of the reference content stored in the ancillary content database 350-2.

When the x-builder application 340 imports content, such as page assets from the master content and course structure database 330-2 and reference content from the ancillary content database 350-2, the x-builder application 340 creates a distinct set of content for an interactive presentation project. The x-builder application 340 imports the content and stores the content in an interactive presentation product build directory on the common files database 330-2. By importing the content to the product build directory, the x-builder application 340 can isolate the content from any changes made to master content and course structure database 330-2.

The x-builder application 340 creates a dictionary for any key terms included in the imported content from the master content and course structure database 330-2. and the ancillary content database 350-2. The dictionary can be a partial dictionary or a complete dictionary. The partial dictionary is limited to the text data terms used in the new interactive presentation project created by the x-builder. The complete dictionary includes all terms that are stored in the ancillary content database 330-2.

The ancillary content database 330-2 can include terms from other interactive presentation projects. For example, the ancillary content database 330-2 can include approved technology terms from a previous technology related e-learning course.

At 534, the x-builder 340 selects a template suite. The x-builder application 340 can select a template suite for the interactive presentation. A template contains variables that define a particular look and feel to the pages of the interactive presentation. The template suite provides a consistent navigational elements and page properties to the interactive presentation. The x-builder 340 replaces the variables in the templates with customized template variables specified by the CME application 330.

At 536, the x-builder application configures the build options. The x-builder can operate in several modes. Sometimes during a question and answer process, some of the build steps can be skipped to expedite build time. For example, a template can be modified and the project regenerated by doing a partial build of the interactive presentation.

At 538, the x-builder application 340 executes the exception-based auto-hyperlinking system. The exception based auto-hyperlinking system can generate hyperlinks linking specific content in the interactive presentation project to glossary definitions or similar subject matter.

According to an embodiment of the present invention, the exception based auto-hyperlinking system automatically generates hyperlinks between keywords in text data and a technical or layman definition. A keyword includes a number of key-fields. Key-fields can include acronyms, primary expansion, secondary expansion, and common use expansion. The acronyms and expasions are ways people describe a term used in common language.

For example, a term such as “local exchange carrier” has an acronym of “LEC.” “Local exchange” is the secondary expansion of the term “local exchange carrier.” Sometimes there are one or more common use expansions.

The exception-based auto-hyperlink system uses intelligent filtering to search text data of page assets for keywords. The intelligent filtering matches words in the text data to a root-word of the keyword. The intelligent filtering can remove or add word endings in order to make a match.

The exception-based auto-hyperlink system uses logic to eliminate invalid matches through a hyperlink validation process. The hyperlink validation process provides a predefined set of rules that are designed to avoid invalid matches. For example, the hyperlink validation process determines compound words, punctuation, spacing and other characteristics to avoid making an invalid match.

The hyperlink validation process can avoid invalid matches that result from duplicate keywords. Duplicate keywords can result from the use of the same acronym in multiple e-learning topics. For example, the acronym “IP” in a computer technology context stands for information protocol, and “IP” in a law context stands for intellectual property. In one embodiment, the hyperlink validation process can determine the context of the duplicate keyword and link it to a definition based on the context that the keyword is used. In another embodiment, the hyperlink validation process can flag the duplicate keyword for human intervention.

The exception-based auto-hyperlink system can be configured to link to a first occurrence on a page, a first occurrence in each paragraph, or every occurrence of a keyword. Links generated by the exception-based auto-hyperlink system can adhere to a display protable of contentsol set by a template suite. The template suite can require a certain appearance of linked keywords.

At 540, the x-builder application 340 imports the time coding information from the CME application. At 542, the x-builder application 340 constructs the individual course pages based on templates. At 544, the x-builder application 340 outputs the interactive presentation in HTML format.

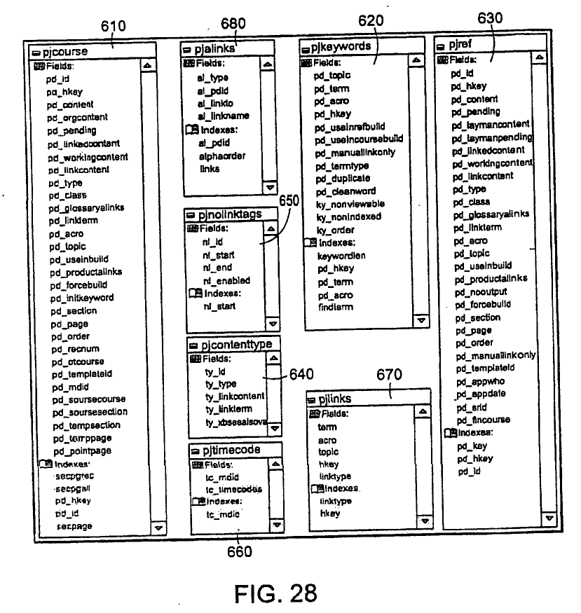

FIG. 28 is a depiction of the x-builder interface displaying the organization of imported content stored in the common files database 330-2. The content stored in the common files database is organized by table. The tables within the database are linked together through the use of identification number fields. The tables organize the course content by class. Each table has a name identifier. It should be understood that the tables can have any name.

A PJCOURSE table 610 stores content for the e-learning course. This content consists primarily of the script and the graphic for any given page in the course. There is one set of records in PJCOURSE table 610 for each page in the course. Within this set of records, there is one record for each element attached to the page in CME application 330. An element can be the script for the page, the graphic that goes on the page, or any number of other elements that control the behavior of the product and the X-Builder itself.

An PJKEYWORDS table 620 stores keywords that are used by the exception-based auto-hyperlinking system. The PJKEYWORDS table 620 primarily stores keywords and classifies the keywords with respective key-fields. The key-fields are used primarily by the exception based auto-hyperlinking system.

For example, the PJKEYWORDS table 620 can have a record with the keyword “LAN” and a record with the keyword “Local Area Network”. These keywords link to the same definition in a PJREF table 630. The PJREF table 630 stores the body of the content for definitions, and for other content.

The PJKEYWORDS table 620 and the PJREF table 630 are primarily used for storing glossary-type data, but are also used to store other content that is hyperlinked into the e-learning course. For example, the tables can store information about a keyword that can be hyperlinked into an e-learning course. Whenever the keyword is mentioned in the e-learning course, a link provided to a specific page that describes that keyword.

A PJCONTENTTYPE table 640 stores information on content types that are utilized in a particular interactive presentation project. Typical content types are “Glossary”, “XYZ company product terms” and any other specific type of data that are used in the exception-based auto-hyperlinking system.

A PJNOLINKTAGS table 650 allows the x-builder application 340 to filter out certain text (stored in the PJCOURSE table) can is not intended to be hyperlinked. For example, HTML bold tags (<B></B>) can be scripted around a keyword. The bold tags can indicate a title of a paragraph. To prevent hyperlinking of paragraph titles the PJNOLINKTAGS table 650 contains a record storing HTML bold tabs (<B></B>). The exception based auto-hyperlinking system then excludes from hyperlinking any text that falls between those particular HTML tags.

A PJTIMECODE table 660 stores time coding information. The time coding information provides for a scrolling text feature in the interactive presentation.

A PJLINKS table 670 is a utility table used to store all the hyperlinks created during the build of a product. It is used only for reference content and debugging.

A PJALINKS table 680 stores data for the “see also” links in the product. For example, the term “router” can be used in the definition for local area network “LAN.” If the interactive presentation includes the term “router,” a “See Also” link can appear at the bottom of the page for “LAN”.

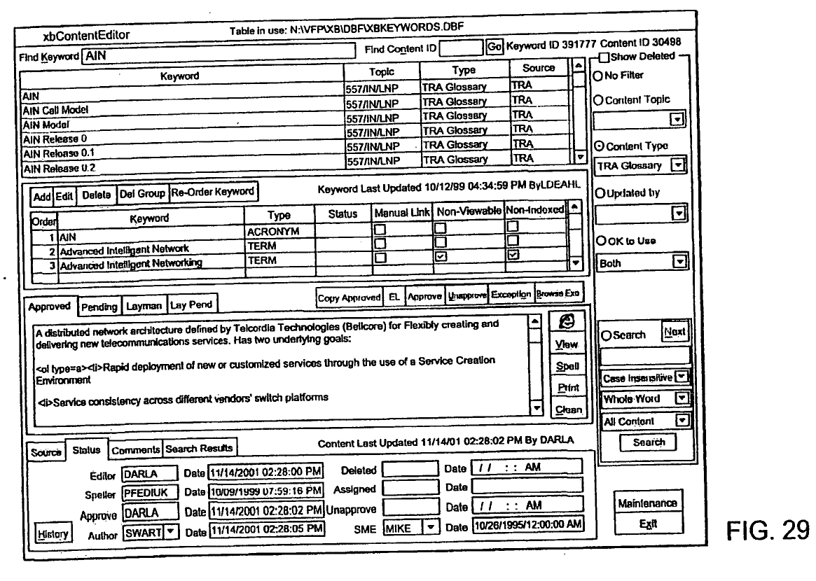

FIG. 29 is a depiction of the interface of an x-builder content editor 350 interface. The x-builder content editor 350 provides the user interface for manipulating reference content stored in the ancillary content database 350-2. The x-builder content editor 350 can add, edit, delete and approve reference content that is stored in the database.

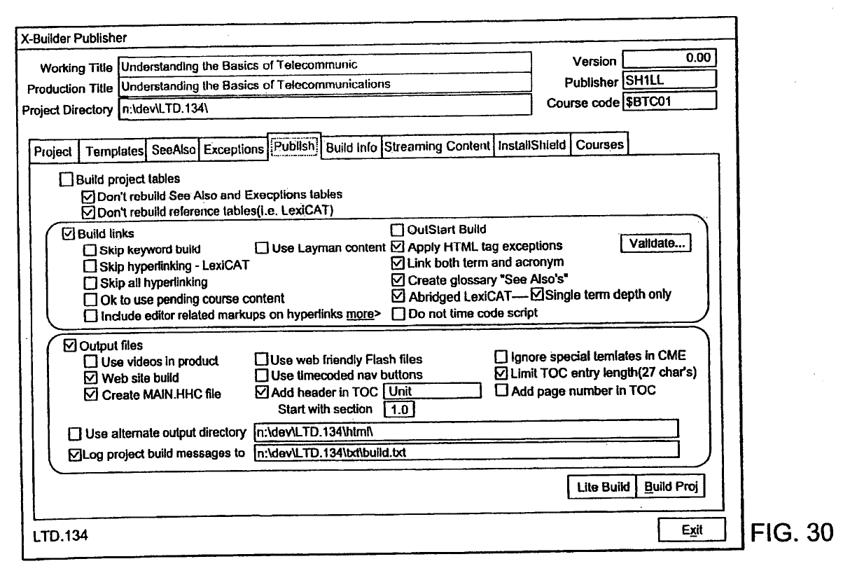

FIG. 30 is a depiction of an embodiment of the x-builder application 340 interface. The x-builder application 340 interface includes a number of features for manipulating the content of the interactive presentation project. The x-builder application 340 interface provides the user interface for manipulating specific rules and preferences used by the exception-based auto-hyperlinking system.

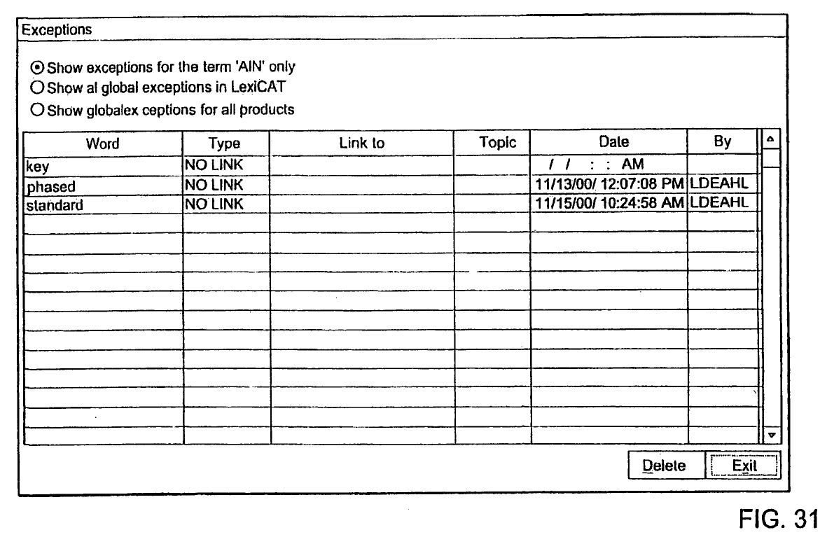

FIG. 31 is a depiction of an embodiment of the x-builder application 340 interface. This embodiment displays the hyperlink exception interface. The hyperlink exception interface provides a user interface for manually eliminating invalid matches via a predefined set of rules.

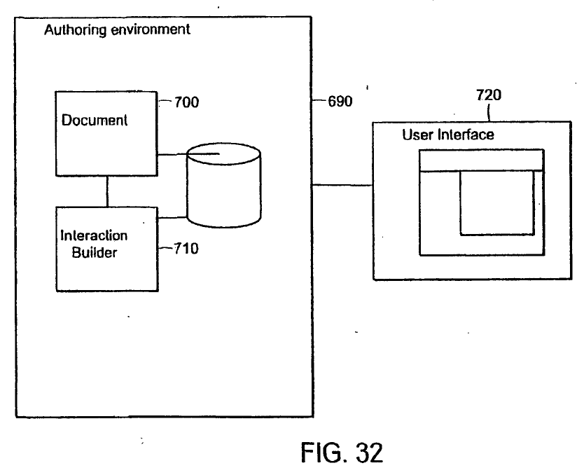

FIG. 32 is a block diagram of the computer systems architecture for creating an interactive presentation according to an embodiment of the present invention. The computer systems architecture provides an authoring environment 690 and a user interface 720. The authoring environment 690 is a document 700 and an interaction builder 710. The document 700 can be in any data processing or web authoring format such as a Microsoft Word, WordPerfect, HTML, Dreamweaver, FrontPage, ASCII, MIME, BinHex, plain text, and the like.

The document 700 can include text, media or code. For example, if the document 700 is a conventional Microsoft Word document, a user can inserts data objects such as text, images, tables, meta tags, and script, into the document. The interaction builder 710 processes all the data objects and converts the document 700 into a HTML document.

According to an aspect of the invention, the document 700 is in a Microsoft Word format and includes headings defined by a Microsoft Word application. For example, text data can be formatted a certain way using the Microsoft Word headings.

The Microsoft Word headings can define the document for the interaction builder 710. The headings in the Microsoft Word document are replaced with HTML header tags (<H1>, <H2>, <H3>, etc.). They can be replaced by the interaction builder 710 or by a conventional Microsoft Word application.

Once the document is in HTML format, the HTML header tags define the structure of an XML document for the interaction builder 710. Specifically, the interaction builder 710 uses the HTML header tags as instructions to build the XML document. The HTML header tags can provide time-coding information to the interaction builder 710. Specifically, the HTML header tags can instruct the interaction builder 710 to synchronize the display of the XML document page assets on the user interface 720.

The HTML header tags can define a type of interaction to be used, such as dichotomous, multiple choice, multiple select, matching, and ordered list. The HTML header tags can define the XML course structure file, and an XML table of contents. The HTML header tags can define new pages, such as the beginning and ending of pages. The HTML header tags enable the interaction builder 710 to build an XML document, which can be generated into an interactive presentation by the XML player for display on the browser user interface 720.

According to an aspect of the present invention, the interaction builder processes pseudo tags written inside the HTML header tags to determine how to build the XML document. For example, brackets such as { }, can be used in connection with the header tags to define further instruction for the interaction builder 710. Specifically, the interaction builder 710 can process such pseudo tags written inside the header tags, and further determine the properties of the page. The tags can indicate the type of data on the page and can define the beginning and ending of a page.

The interaction builder 710 processes the tags in the HTML document 700 and places the HTML document 700 into an XML document. The interaction builder 710 builds the XML data based on the HTML header tags. The XML data defines a tree structure including elements or attributes that can appear in the XML document. Specifically, the XML data can define child elements, the order of the child elements, the number of child elements, whether an element is empty or can include text, and default or fixed values for elements and attributes, or data types for elements and attributes. It is preferable that the XML document is properly structured in that the tags nest, and the document is well-formed.

The interaction builder 710 supplies the XML player with the XML data. The XML player compiles the XML data in the XML document for display in a browser on the user interface 720. In particular, a JavaScript program, that is included in the XML player, parses the XML data and displays it in a browser as HTML. The parser also utilizes parsing functions that are native to the browser.

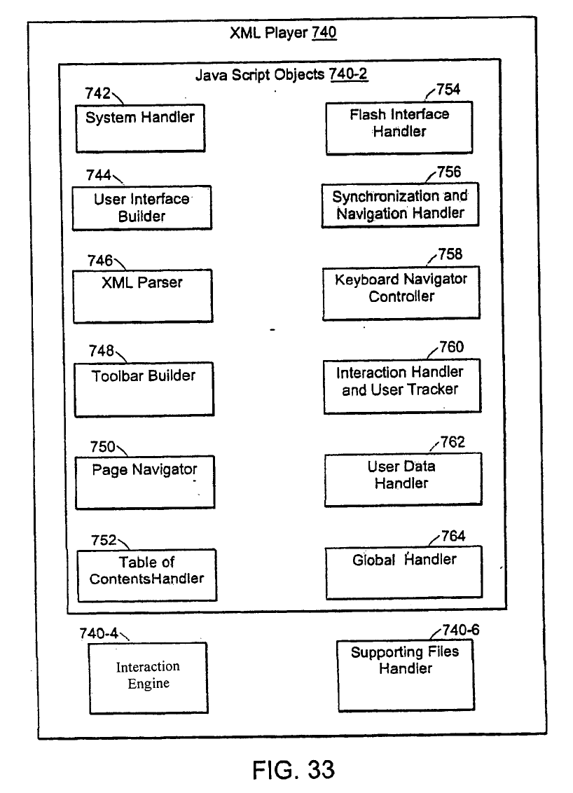

A diagram depicting an embodiment of the XML player 740 is shown in FIG. 33. The XML player 740 is comprised of three general components: JavaScript programs 740-2, an interaction engine 740-4 (written in a Flash ActionScript file) and other supporting files 740-6.

The JavaScript programs 740-2 perform a variety of functions for the XML player 740. A system handler 742 audits the system requirements to make sure that the interactive presentation can load on the client system. A user interface handler 744 builds the user interface for the interactive presentation.

An XML parser 746 parses the XML data, such as XML data page assets, and builds an interactive presentation course structure file in memory. The XML parser proceses the XML data and renders it into a format that the browser requires. The browser includes functions that are native to the browser that can assist the XML parser 746 in rendering the XML document. The browser then interprets the rendered XML document and displays it. The XML parser 746 also handles the XML data that are processed by the hyper-download system.

A toolbar builder 748 builds the main menu for the interactive presentation product. A page navigator 750 handles page navigation through the interactive presentation. A table of contents handler 752 provides table of contents navigation based on the course structure file. A Flash interface handler 754 setups the primary Flash interface. A synchronization and navigation handler 756 loads animations with the status bar, and handles navigation of the closed captioning region of the user interface. A keyboard navigation controller 758 handles navigation events associated with keystroke interactions. An interaction handler and user tracker 760 tracks and scores user's interactions. A user data handler 762 handles user data such as cookie indicators that are stored on the client system 130 or on the server 120, such as the learning management sever. A global handler 764 handles commonly used subroutines.

In general, the XML player's 740 interaction engine 740-4 generates the interactions. By way of background, conventional e-learning interactions are often characterized by their rigid testing structure, and discouraging learning environment. Such e-learning interactions often fail to compensate for the fact that the instructor interactive component is lacking in the e-learning environment. With the XML player 740, however, the interactive presentation can provide a comfortable and encouraging learning environment for the user. For example, the interaction engine 740-4 can process the interactions, and provide feedback to the students when they answer questions associated with the interaction. The XML player 740 can allow students to compare their answers with the correct answer, even if they have not finished the interaction. In fact, they can compare the answers that they have completed with the correct answers, without being revealed any answers that they have not completed. The interaction engine 740-4 gives partial credit to answers. The XML player 740 can also allow the interactions to be graded at any time.

The components of the XML player 740 may be bundled together into a plug-in for the browser. For example, the JavaScript programs 740-2, an interaction engine 740-4 and other supporting files 740-6, such as GIFs, and HTML files, are bound together into an ActiveX DLL file, and installed into the browser. The XML player 740 could also be a Java Applet.

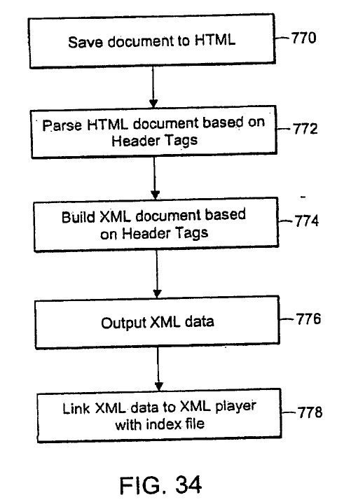

FIG. 34 is a flow diagram depicting the authoring process associated with authoring system of FIG. 32. At 770, the authoring system saves a document file to HTML format. At 772, the HTML document is parsed based on the heading tags. At 774, an XML document is built based on the HTML tags. At 776, the HTML document is output as XML data. At 778, the XML data is linked to the XML player with an index file. The index file initiates the XML player 740 of FIG. 33 by pointing it to the XML data. This launches the interactive presentation course.

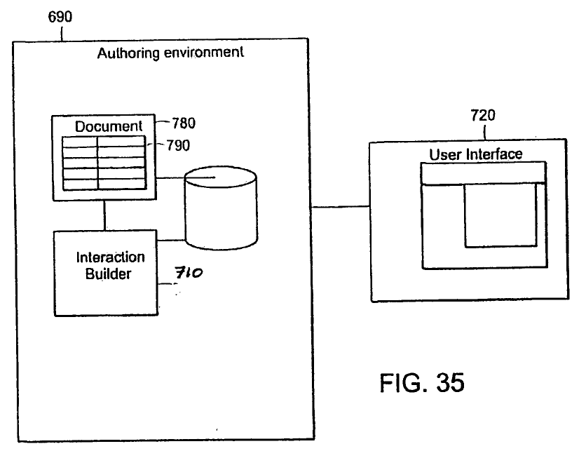

FIG. 35 is a block diagram of the computer systems architecture used to create an interactive presentation according to an embodiment of the invention. According to an aspect of the present invention, the document 780 includes a table 790. The document 780 can be any type of word processing document that can include tables. The document 780 and its table are processed into HTML format, and then processed into an XML document. Specifically, the table 790 defines the XML document that includes a specific interaction. An interaction builder 710 can determine the type of interaction defined by the table using a number of factors associated with the table 790.

The factors associated with the table 790 include: a type of data stored in the cells, specific text stored in the cells, a number of cells, rows, and columns of the table. These factors define a particular interaction for the interaction builder 710 to build in an XML document. Specifically, the data stored in the cells of the table 790 can instruct the interaction builder 710 to include that data in the interaction to be built by the interaction builder 710. The factors associated with the table 790 can instruct the interaction builder 710 on time-coding the animation video region, table of contents, closed captioning region, and toolbar. Specifically, factors associated with the table 790 can instruct the interaction builder 710 as to how to synchronize the assets of the XML document displayed on the user interface.

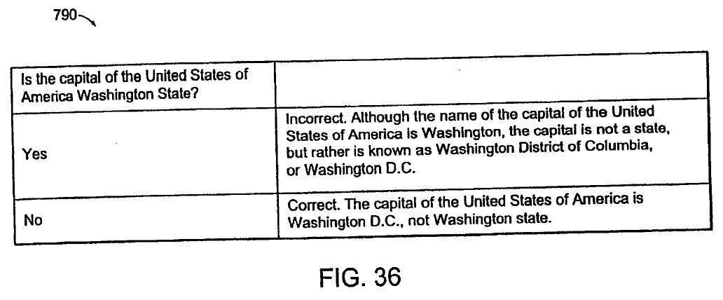

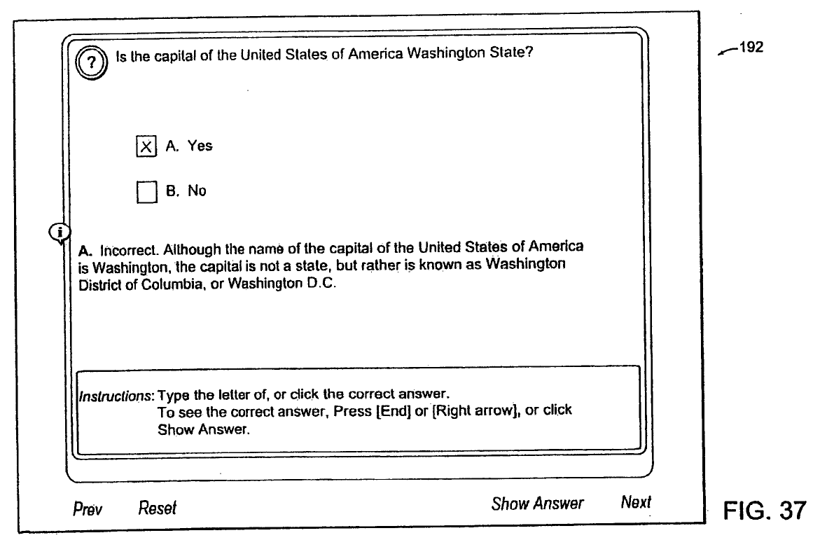

The factors associated with the table 790 cause the interaction builder 710 to build an interaction that is either dichotomous, multiple choice, multiple select, matching, or ordered list, and include text or media data, which corresponds to the content stored in the cells of the table. For example, FIG. 36 is a depiction of a table corresponding to a dichotomous interaction. Once the interaction specified in the table is processed by the interaction builder, the dichotomous interaction is generated as shown in FIG. 37.

The system uses a number of factors and indicators to determine how to generate the contents of the table 790 into an interaction. The contents of the table 790 may be inserted into particular cells and rows in accordance with a pattern. The system can use this pattern to identify the type of interaction specified in the table 790. For example, the columns and rows can be used to identify the interaction type, e.g. first column of the table 790 is associated with the question and the second column is associated with the answer. The type of interaction can be based on the specific terms (character strings) associated with interactions, such as “correct,” “incorrect,” “yes,” and “no.” The type of interaction can be determined by examining if specific characters or operators are present, such as punctuation (e.g. question marks to determine which cell includes a question for the interaction).

Once the interaction builder processes the HTML table and determines the type of interaction, the interaction engine stores the text data of the table cells as variables into a string. The HTML document is then placed into an XML document, and can be displayed by the XML player.

When the XML document is displayed on the user interface by the XML player, the interaction engine generates an interaction that integrates the text data stored as variables in the string. Specifically, the text data originally in the table 790 is displayed as part of the interaction. FIG. 37 is a depiction of a dichotomous interaction displayed according to an embodiment of FIG. 36. The text data in the cells of the table of FIG. 36 are integrated into the dichotomous interaction shown in FIG. 36.

According to an embodiment of FIG. 35, the table 790 cells can include references to media elements, such as filenames for graphics, that can be integrated into the interaction. The interaction builder 710 or XML player uses the indicators specified in the table 790 to determine the type of interaction. The media elements are stored into an HTML string, and the HTML document is processed into XML format.

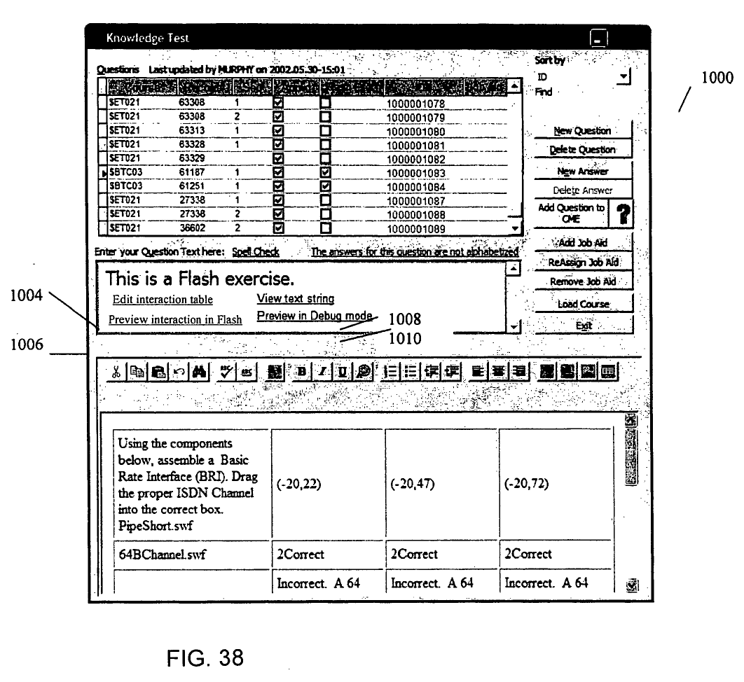

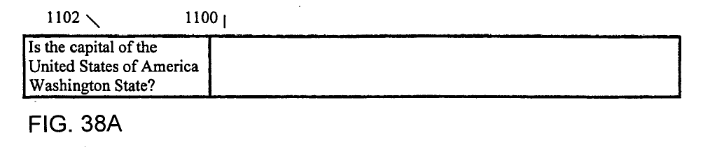

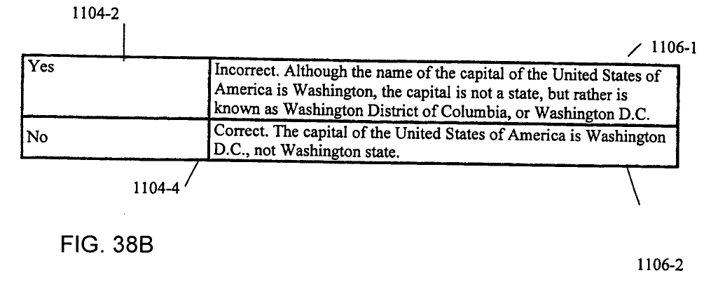

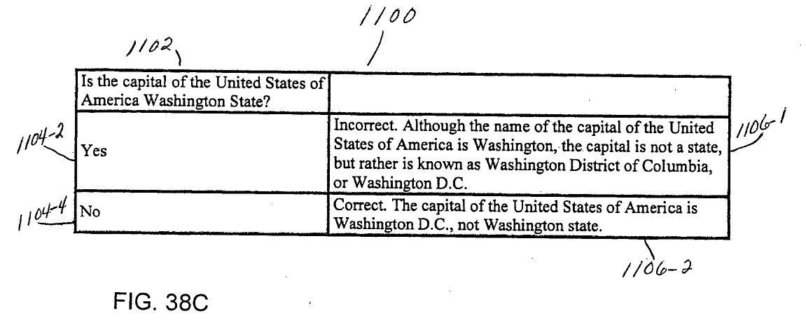

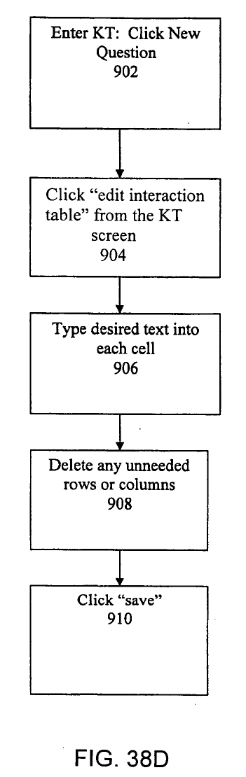

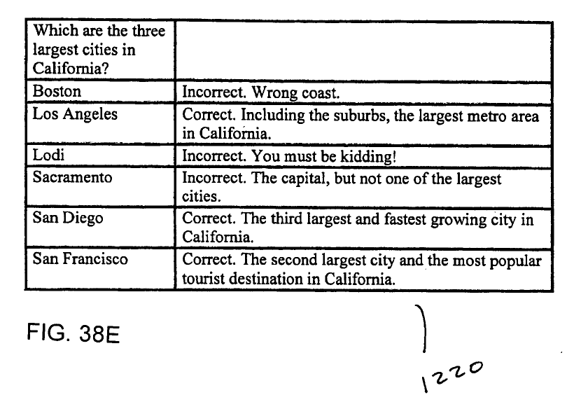

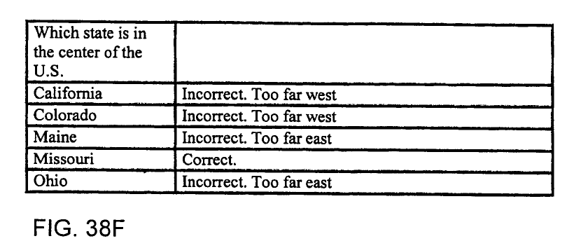

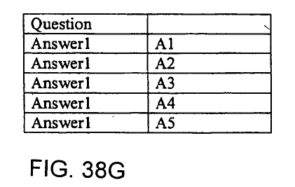

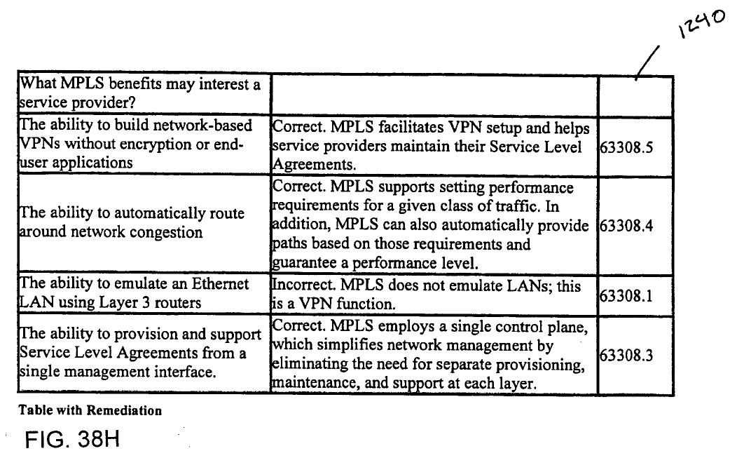

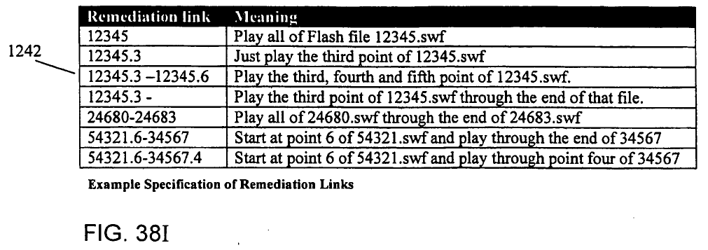

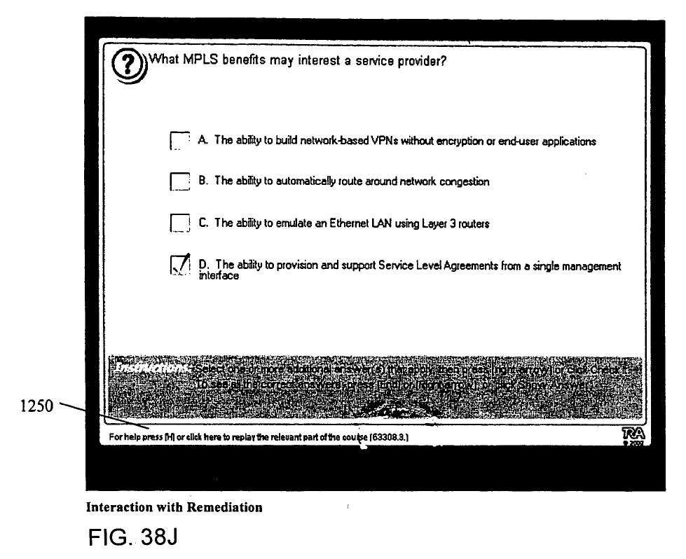

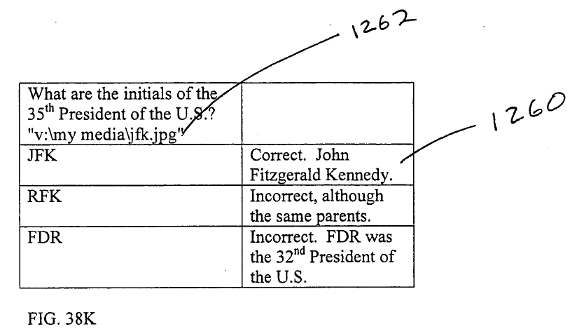

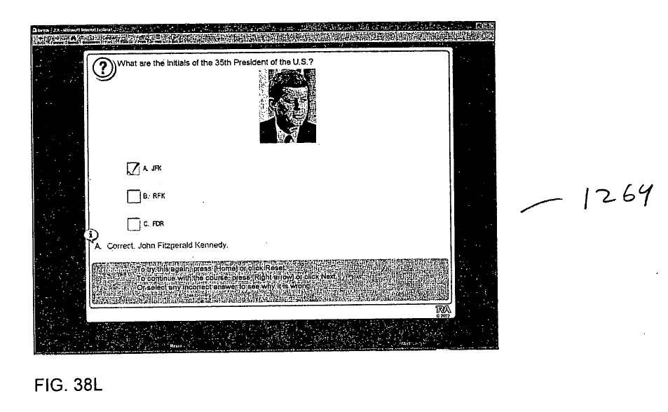

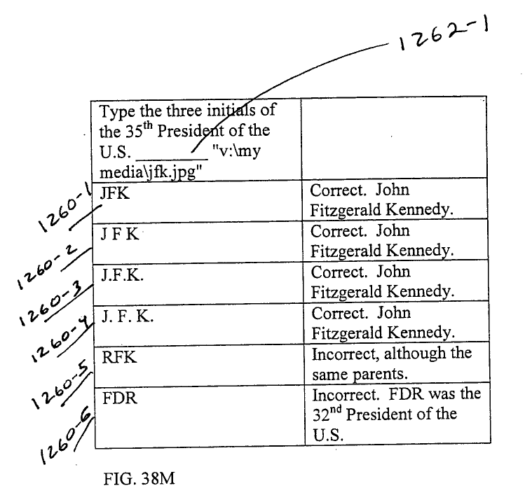

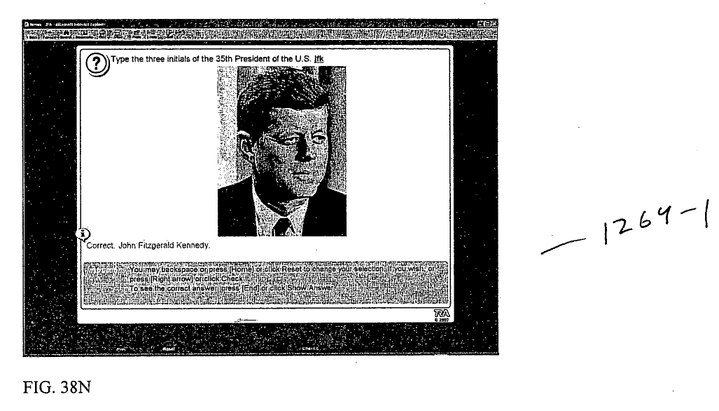

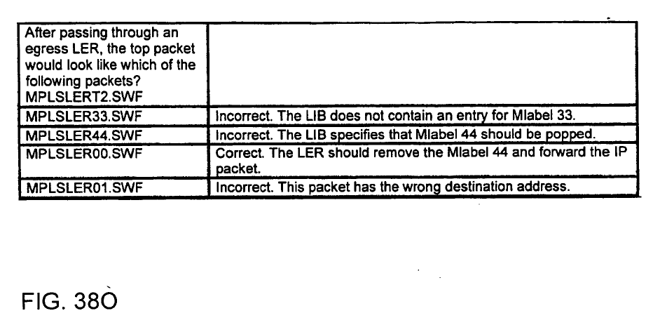

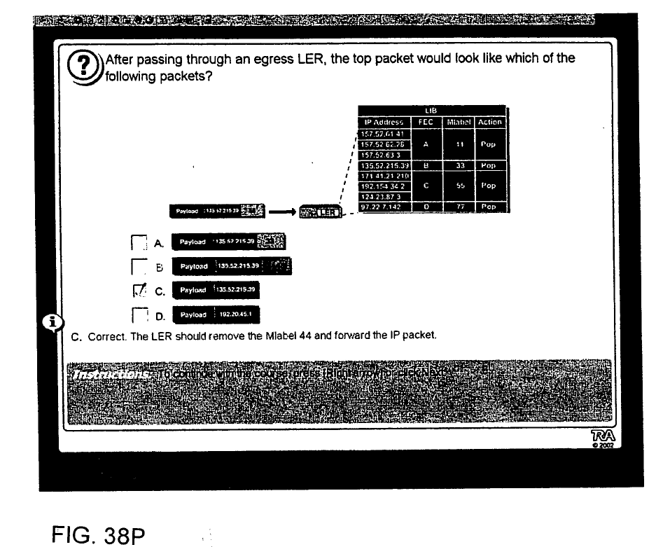

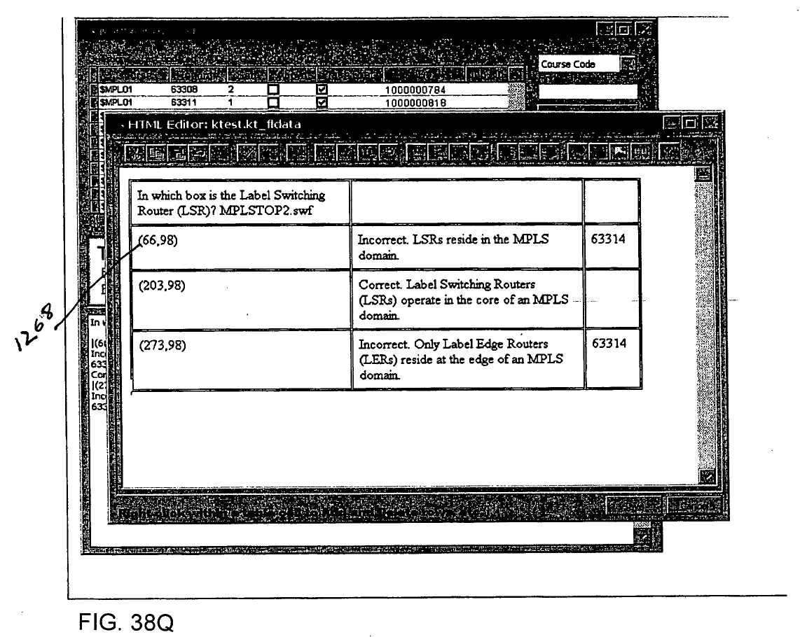

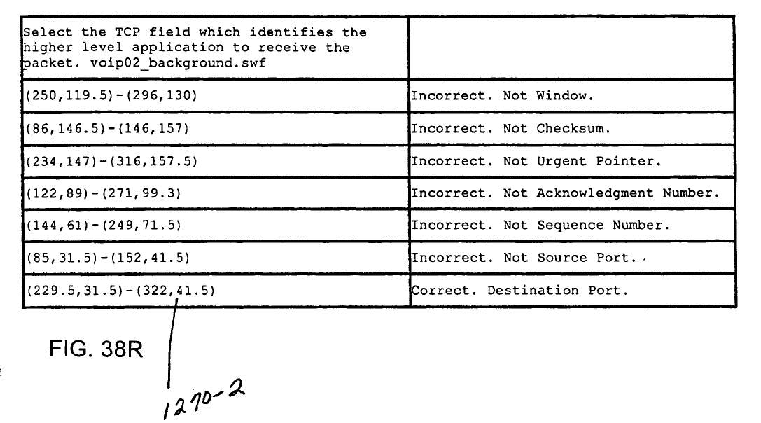

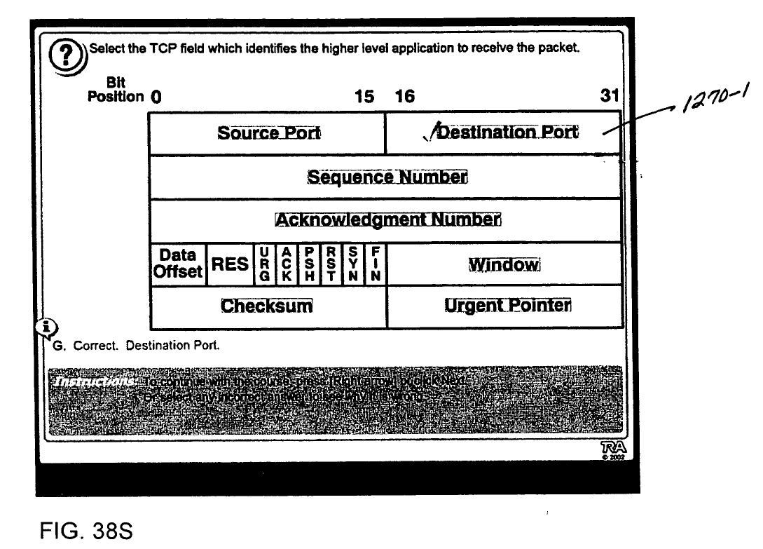

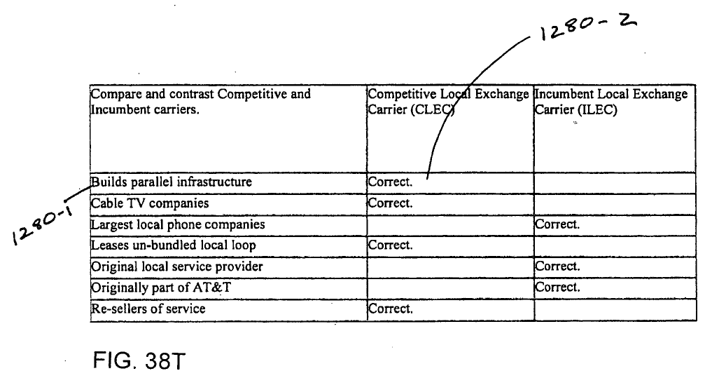

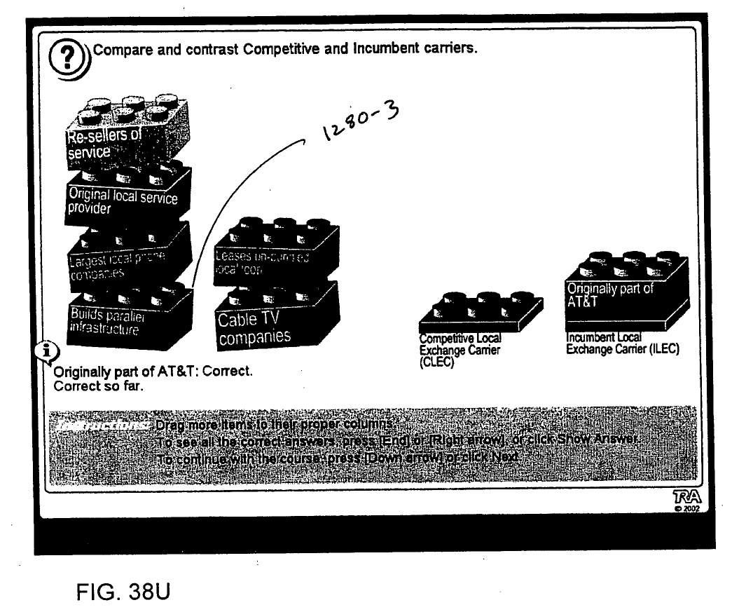

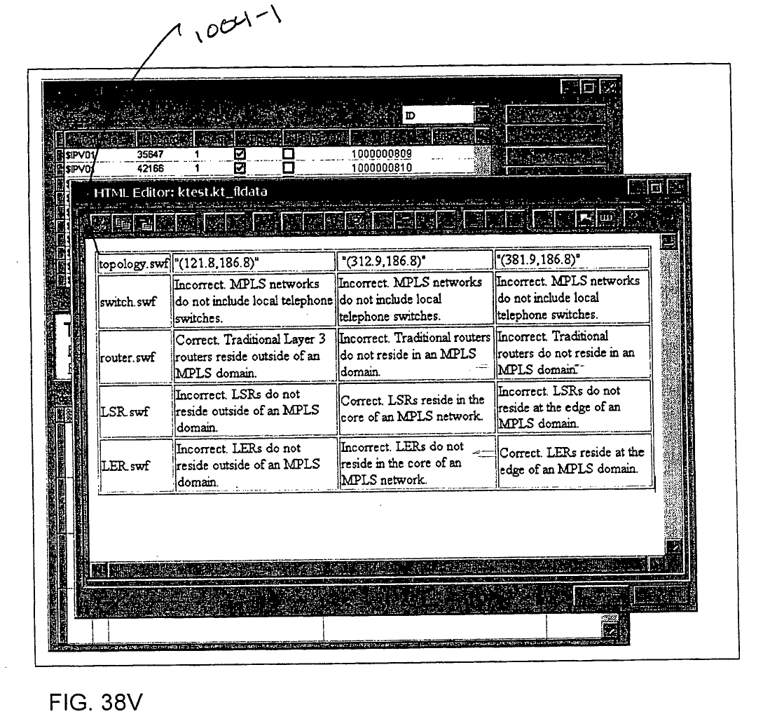

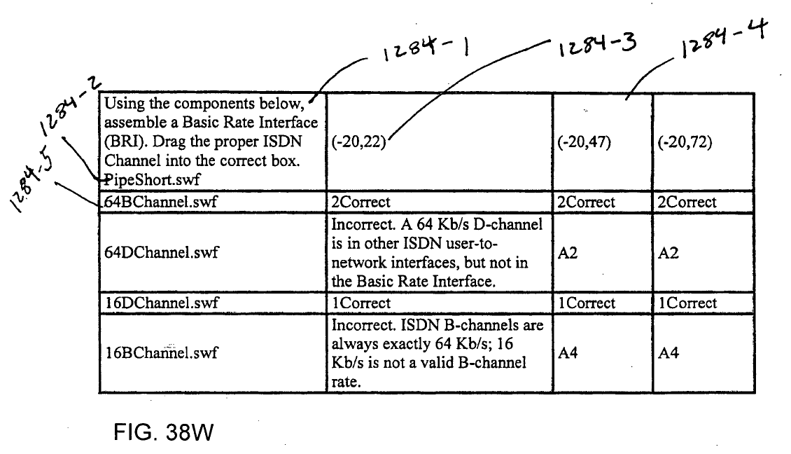

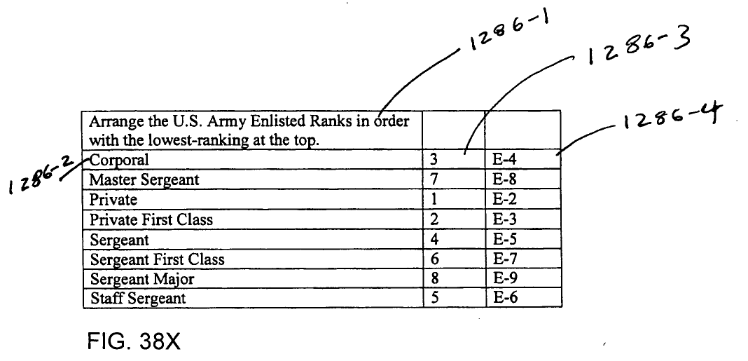

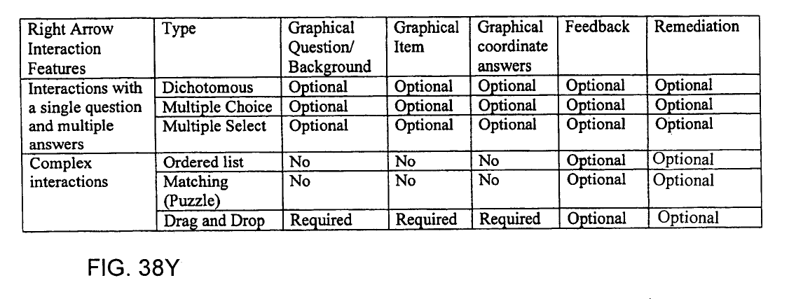

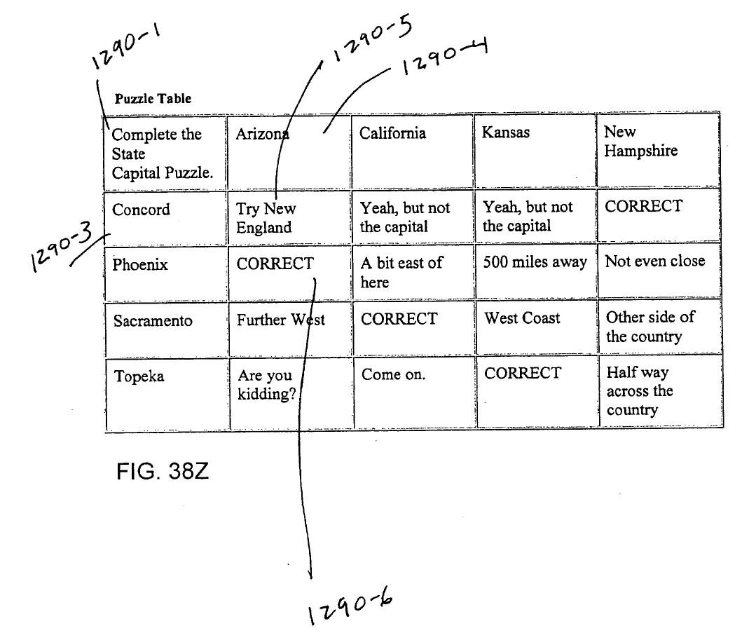

An embodiment of the Knowledge Test™ graphical user interface 1000 is shown in FIG. 38. Knowledge Test exports a finished interaction in Macromedia Shockwave format delineated by the suffix, “.swf”. The interaction may contain text, graphics, or any combination thereof. Creation of new graphical interactions simply requires placing the necessary element names or text in a table 1002.

The basic Knowledge Test interface 1000 displays everything necessary to create a new Flash interaction or edit an existing interaction. The Knowledge Test interface also contains four links 1004, 1006, 1008, 1010. These links 1004, 1006, 1008, 1010 open various windows for a developer to create, edit, and test their graphical or text based interactions. For example, the Edit Interaction Table link 1004 opens a window containing the table 1004-1 in an editor used to create/edit interactions as shown in FIG. 38V.

Referring to FIG. 38, the Preview Interaction in Flash link 1006 opens a new browser window that renders and displays a temporary version of the interaction regardless of completion status. The View Text String link 1008 displays the current given interaction table translated to an HTML string for interactions.swf. The Preview in Debug Mode link 1010 opens a new browser window that renders and displays a temporary version of the interaction with additional information visible such as .swf element name and coordinate location on screen.

A single question interaction, such as dichotomous, multiple choice or multiple select interaction, is typically represented in a table, consisting of rows and columns. FIGS. 38A-C are depictions of example data table content for a single question interaction. The first table row 1100=displays the question in the left cell 1102. Each subsequent row contains an answer in the left cells 1104-2, 1104-4 and feedback in the second cells 1106-2, 1106-4. When the first seven letters of the second cell 1106-4 contain the word “Correct” the row represents a correct answer. Otherwise, the row represents an incorrect answer, also known as a distracter. To indicate a distracter, the first nine letters of the second cell for each incorrect answer row can be “Incorrect.” The course developer can also include additional feedback in the second cells 1106-2, 1106-4. A student (e.g. learner) selecting this answer will see this feedback.

Previewing feedback for each wrong answer can be very valuable for the students. Feedback can enable a student (user) to get back on track in an almost personal way. Feedback may also be useful for correct answers. Feedback should not be confused with remediation. Feedback is written in the second cell of each answer to give the student specialized help. Remediation, however, provides a link to the record in the course that explains the material. FIG. 38Y is diagram depicting different features associated with the various types of interactive exercises. As shown in FIG. 38Y, all interactions support feedback and remediation.

There are two techniques for entering text for an interaction. If the table has been created using a word processor (e.g. Microsoft Word, email software, etc) then the content can be copied and pasted into the Knowledge Test software depicted in FIG. 38 as follows:
1) Select the appropriate table from a storyboard document, email, etc.;
2) Copy the table to the clipboard;
3) Enter Knowledge Test: Click New Question;
4) Click “edit interaction table” from the Knowledge Test screen;
5) Right click Select all;
6) Press the Delete key to delete the entire empty table;
7) Paste the selected table into the “edit interaction table” screen; and
8) Click “save.”
   The ability to email an interaction in the form of a table provides unique flexibility in developing interactions. For example, developers can email one another draft versions of the interactions, and they can modify the interaction directly in the email. This flexibility creates an authoring environment that allows developers to easily manipulate, share, and design interactions without having to use particular software or be connected to a database.

FIG. 38D is a flow diagram depicting the process of specifying table content using the Knowledge Test software. At 902, the Knowledge Test application is initialized and new question is selected. At 904, the “edit interaction table” is selected from the Knowledge Test interface. At 906, the desired text for the interaction, such as the questions and answers, are entered into each cell. Any unneeded rows or columns are deleted at 908. The interaction is saved at 910.

An interaction with more than one correct answer, known as multiple select, can be created by adding more rows with correct answers. For example, FIG. 38E is a depiction of example table content for generating the multiple select interaction of FIGS. 8A-B. As shown in FIG. 38E, the developer can introduce additional rows in the table 1220 with the term “correct” to indicate that this is one of the correct answers.

The text in the tables is processed by the interaction builder and XML player into a multiple select interaction, as in FIG. 8A. When the user selects the “Check It” button, the user's selections are graded, as shown in FIG. 8B. In this case, the user made three selections, 1222-1, 1222-2, 1222-3, and only two of them, 1222-1, 1222-3, were correct, as shown in FIG. 8B.

FIG. 38F is a depiction of example table content used to generate feedback in an interaction. The developer may use identical feedback for more than one incorrect answer, as shown in FIG. 38F. Instead of requiring the developer to enter in the same information over and over, developer can specify feedback in one cell and subsequently refer to that cell in other cells.

FIG. 38G is a depiction of example table content used to reference feedback according to an embodiment of FIG. 38F. As shown in FIG. 38G, the first feedback cell is addressed as AI, the next one down as A2, etc. Thus, the developer need only enter each feedback once, referencing it by cell address on other rows, as discussed above.

Remediation may be specified in the table. FIG. 38H is a depiction of example table content used to generate remediation in an interaction. For single answer questions such as, dichotomous, multiple choice or multiple select questions, the developer may optionally use a third column 1240 to specify a remediation record number, as shown in FIG. 38H. FIG. 38I is a depiction of example table content used to reference a start point and end point in a Flash file. A content developer to use a remediation table, as shown in FIG. 38I, to link to a specific section in a Flash file by indicating the starting point and ending point of the Flash file in the table. For example, the remediation link number 1242 is referenced in the first column, and the starting and ending points of the flash file e.g., [.starting point] [−ending point], are referenced in the next column of their respective row.

FIG. 38J is a depiction of the interaction generated from the table content of FIG. 38H. Before the student selects any answers, the content in the remediation column of the first row, if any, is used in the corresponding interaction, such as that shown in FIG. 38J. For example, if a user clicks the button 1250, which reads “Click here to replay the relevant part of the course . . . ” they will be navigated to that page in the course. Upon completion of that page or upon clicking return, they will have the opportunity to return to that interaction and answer the question again. If the user selects more than several answers, the remediation associated with the first wrong answer is used, if it exists, otherwise the remediation column in first row is used.

For single answer questions (e.g., dichotomous, multiple choice or multiple select questions), a graphic can be associated with the question or the answers. Typically, each graphic that is a background for a question is stored in an individual .swf file, and centered, even without specifying x or y coordinate displacements. The actual size of the graphic is not important, as the XML player will scale it to the space available.

A graphical background can be used with most types of interaction. The dimensions of a background graphic will be adjusted automatically by the present system to a width of 560 pixels, or smaller. The height will be adjusted to allow space for draggable objects, questions, feedback, etc., typically 200 pixels. Thus, interactions look better if their backgrounds are designed wider than the standard 4×3 computer screen aspect ratio.

The interaction builder typically will generate an interaction with predetermined graphics, however, the interaction builder also allows the developer to supply their own graphics. Puzzle interactions, however, typically do not contain developer supplied graphics, and instead contain graphics generated by the invention. In general with puzzle interactions, the developer specifies only the text that will appear in the puzzle, question, pieces and slots.

FIG. 38K is a depiction of example data table content for a multiple choice interaction. FIG. 38L is a depiction of the multiple choice interaction generated from example data table content of FIG. 38K. A multiple choice interaction typically has only one correct answer, such as indicated by the first column of a table 1260, as shown in FIG. 38K, containing only one correct indication beginning with the letters “Correct.” The developer can quickly improve the appearance of a text question, such as a multiple choice interaction, merely by adding an existing library symbol to the question. The symbol is specified by its filename at the end of the left cell of the first row of the table, in this case, jfk.jpg 1262. The table is generated into a multiple choice interaction 1264 with a graphical background, as shown FIG. 38L.

Fill in the blank exercises are a form of multiple choice exercises. FIG. 38M is a depiction of the data table for a fill in the blank interaction. FIG. 38N is a depiction of the fill in the blank exercise generated from example data table content of FIG. 38M. Although the fill in the blank and multiple choice exercises are specified similarly in the data table, the system determines that a fill in the blank exercise is present by identifying the underscore characters 1262-1 in the question. The number of underscore characters specified in the question corresponds to the amount of character letters in the correct answers 1260-1, 1260-2, 1260-3, 1260-4. Incorrect answers 1260-5, 1260-6 can be specified in the same column. The present system catches keystrokes inputted by the user, and inserts the keystrokes into the question 1262-1. The content from the table shown in FIG. 38M is extracted an used to generate the fill in the blank interaction 1264 shown in FIG. 38N.

Multiple choice interactions can include a combination of graphical backgrounds and answers. For example, FIG. 380 is a depiction of the data table for multiple choice interaction with a combination of graphical background and answers. FIG. 38P is a depiction of the multiple choice interaction with a graphical background and answers generated from example data table content of FIG. 38P.

Graphical coordinates are used in both hot spot multiple choice/select questions and drag and drop interactions. The designer specifies hot spots for the interaction using answers consisting of coordinates on the specified background graphic. FIG. 38Q is a depiction of a word processing table editor with a data table having graphical coordinates. The editor can be used by a developer to create a graphical interaction. For example, coordinate information 1268 to identify hotspots can be specified in the table. In general, each graphical coordinate is specified as follows:
1) Left parenthesis;
2) x-coordinate (in pixels from the left side of the background .swf.);
3) Comma;
4) y-coordinate (in pixels from the top of the background .swf.);
5) Right parenthesis;
6) Nothing else can be in the cell;
7) The coordinates must be specified in relation to the dimensions of the graphical background, not the dimensions of the screen itself; and
8) Coordinates that are outside the borders of the background graphic may be specified (e.g. negative numbers are used above, and to the left of the background).

FIG. 38R is a depiction of a data table with graphical coordinates specified in pairs. FIG. 38S is a depiction of the interaction generated from the table content of FIG. 38R. As shown in FIG. 38R, for multiple choice/select questions, the developer can control the size and shape of each hot spot 1270-1 by specifying graphical coordinates in pairs 1270-2. Typically, each graphical coordinate pair must be specified exactly as:
1) Graphical coordinate (as above);
2) Hyphen;
3) Graphical coordinate (as above); and
4) Nothing else can be in the cell.

A puzzle is a type of drag and drop matching interaction. Matching interactions do not have a single question, but rather a number of text or graphic elements that must be matched. Puzzle interactions are a special type drag and drop interaction consisting of a puzzle graphic with up to four labeled holes and up to four pieces that the user drags into the correct hole. Since typically the developer does not provide graphics for puzzle interactions, the developer can construct these interactions very quickly.

For more realistic and more difficult drag and drop or puzzle interactions, the developer may specify that the same object correctly goes into two different slots. In this case, as soon as the user touches that object in the boneyard and moves it, a clone of this object is generated behind the original, giving the user the appearance of a stack of two objects. The boneyard is a slot or designated area on the interface of the interaction where pieces (e.g. objects) are kept until they are used. Once the user drags a piece from the boneyard, a clone of the piece is created. In general, the clone is a copy that Flash generates based on the piece, such as a child piece, and it is identified as a clone in order to keep track of it and distinguish it from the original piece (the parent). Although Flash makes a distinction between the original object and the clone, advanced functions in the XML player make both objects appear identical to the user. Even if they only have one correct slot, all objects will exhibit this treatment to avoid “giving away” to the user that an object correctly goes into only one slot, unless the developer specifies difficult=“n”.

Puzzle interactions, such as the interaction shown in FIG. 10A, typically include only text supplied by the content developer. If the items to be matched contain no graphics and text less than 25 characters each, the invention enables the designer to create a puzzle interaction very quickly.

FIG. 38Z is a depiction of example data table content for the puzzle interaction of FIG. 10A. The developer usually specifies the matching interaction in a table with the general instruction in the upper left corner 1290-1, such as “Complete the State Capital Puzzle” of the table in FIG. 38Z. Specific instructions to the user (e.g. learner) are automatically provided by the software in the instructions field in the lower part of the screen 1290-2, shown in FIG. 10A. Referring to FIG. 38Z, other than the upper left hand corner, which contains instructions 1280-1, the left column contains the text labels for pieces of the puzzle 1290-3, and the top row contains the labels 1290-4 for the slots in the puzzle board.

For each combination of piece 1290-3 and slot 1290-4, the developer provides appropriate feedback 1290-5 at the intersection of the respective piece row 1290-3 and slot column 1290-4. The feedback for the correct selection will start with the word “Correct” 1290-6.

While the puzzle model readily models many interactions, it has the limitation that each slot can only hold one piece. More complex text interactions can be handled with a building block model that allows more than one piece per column. For example, FIG. 38T is a depiction of example data table content for a building block interaction. FIG. 38U is a depiction of the building block interaction generated from example data table content of FIG. 38T. The table used to create the building block interaction is shown in FIG. 38T. To create such an interaction, the developer can specify that pieces (objects) 1280-1 belong in multiple columns 1280-2. For example, the answer piece 1280-1 defined in FIG. 38T corresponds to the answer piece (building block) 1280-3 shown in FIG. 38U. It should be noted that the building block interactions may also be referred to as compare and contrast interactions.

A graphical drag and drop can easily be created from an existing Flash course graphic provided by the invention. First, the developer “cleans up” the image by removing all extraneous words and graphics. Then, the artist cuts out several items to be dragged, storing each in a separate .SWF file. Finally, the remaining background is stored in an .SWF. For example, FIG. 38W is a depiction of example data table content used to generate the building block exercise of FIGS. 9A-B. In the table shown in FIG. 38W, the upper left hand cell contains a question 1284-1, and following the question 1284-1 is the filename of the graphical background 1284-2.

Drag and drop interactions typically require that the student or user drag items (objects or pieces) one at a time to the correct drop zone. The filenames 1284-5 of the items to be dragged are specified vertically in the first column starting with the second row. The drop zones are specified horizontally in the first row starting with the second cell. The coordinates of the drop zones 1284-3 are specified in the top row of the table.

Drag and drop interactions can simulate alternative configurations such that the desired correct location of a particular answer may be more than one location within the background graphic. A developer specifies alternative configurations by showing “correct” not only multiple times in a row, but also multiple times in a column 1284-4.

Using this feature, the instructional designer may specify a correct answer as containing a specific number of occurrences of each object. This is specified as a single digit immediately before the word “correct.” The answer in the example includes:
1) Two 64BChannel.swf s; and
2) One 16DChannel.swf's.

If the student answers part of the question correctly, then requests “Show Answer,” the invention software will provide the remaining correct answer(s) without changing the correct answer(s) supplied by the student.

In general, drag and drop interactions consist of a large developer-supplied graphic background with up to 25 drop zones (whose x,y coordinates have been specified by the developer, (e.g. holes or slots)) and in some embodiments of the invention, up to 25 small graphic objects provided by the developer. Initially, the objects are in the order specified by the developer in a horizontal bone yard at the above the background graphic. Occasionally, with very long objects, special heuristics are used to determine the location of a vertical bone yard to the left of the background graphic. This allows both the objects and the background graphic to be scaled somewhat larger than if the objects had been in a horizontal boneyard. Typically, the user drags each object to the appropriate slot, if any (some objects may be distracters and have no correct slot in which to move).

Ordered list interactions, such as that shown in FIG. 11, presents the student with a list of items that are to be placed a specified order. For an ordered list interaction, the objects are initially in the order specified by the developer. The user is presented with the task of dragging these into the correct order. FIG. 38X is a depiction of example data table content for the ordered list interaction of FIG. 11. As shown in the table of FIG. 38X, the question 1286-1 is entered in the upper left hand corner. One row is entered for each item to be ordered, with the item name in the left cell 1286-2. These are entered in the order to be displayed; typically alphabetically. The second cell 1286-3 defines the desired order. The optional feedback is entered in the right cell 1286-4.

Even though most or all of the items are not in the exact correct place when the student clicks on Check It 1286-5, heuristic algorithms detect the minimum items to be moved and mark only them incorrect.

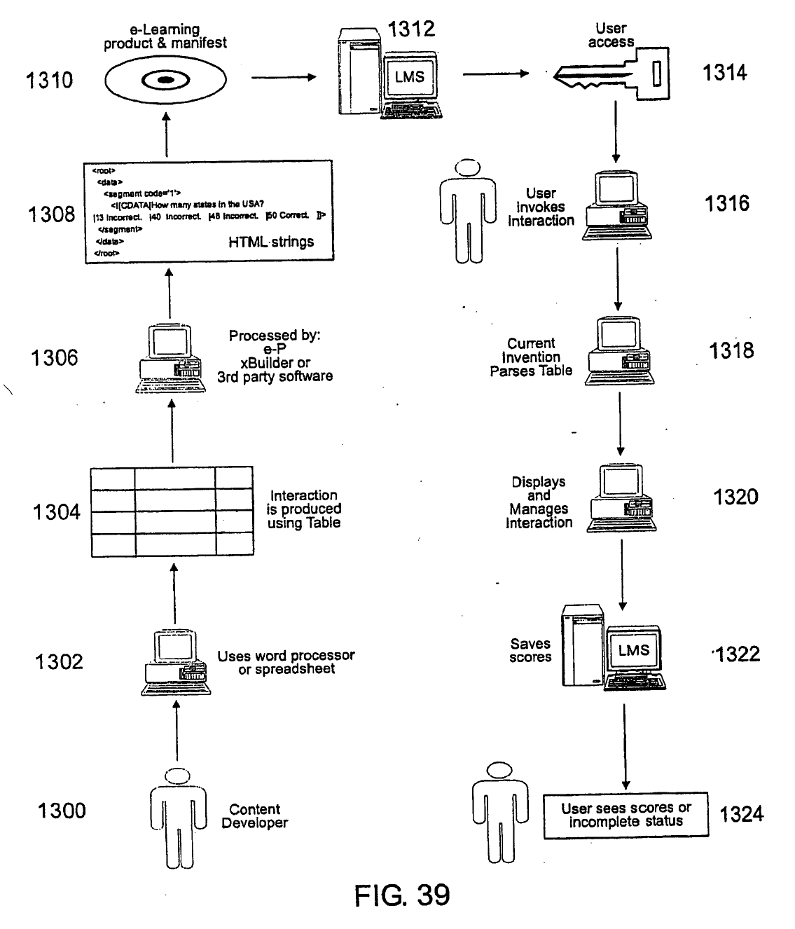

FIG. 39 is a flow diagram of the process of creating an interaction according to an embodiment of the invention. The content developer 1300 uses a word processor, spreadsheet, or KnowledgeTest™ software 1302 to specify an interaction or quiz to the invention. For example, an interaction can be produced from a table 1304. The table may be processed by an e-learning authoring system such as e-Presentor™ or XML Player™ or third party software 1306 to generate an HTML string 1308, representing the data appearing in the table.

At 1310, the e-learning course may be stored on a CD. The course may be transferred 1312 to a learning management system (LMS), such as Docent, Saba, Isopia, etc. The LMS may be located a university or company, or remote location to allow users (e.g. students or personnel) to take the e-learning course. At 1314, the user obtains access to the course. Interaction with the course 1316, such as taking a test or evaluation, causes interactions to be generated at 1318. The interactions are extracted from data tables, which may be stored into a string. The string is parsed at 1318, and at 1320 the interaction is generated. The course includes software components, such as an interaction handler and XML player, which display and manage the user interaction. The software stores the state of the interaction in strings, which are saved at the LMS. In this way, the user's scores can be saved, and the user can request to view their current score at 1324.

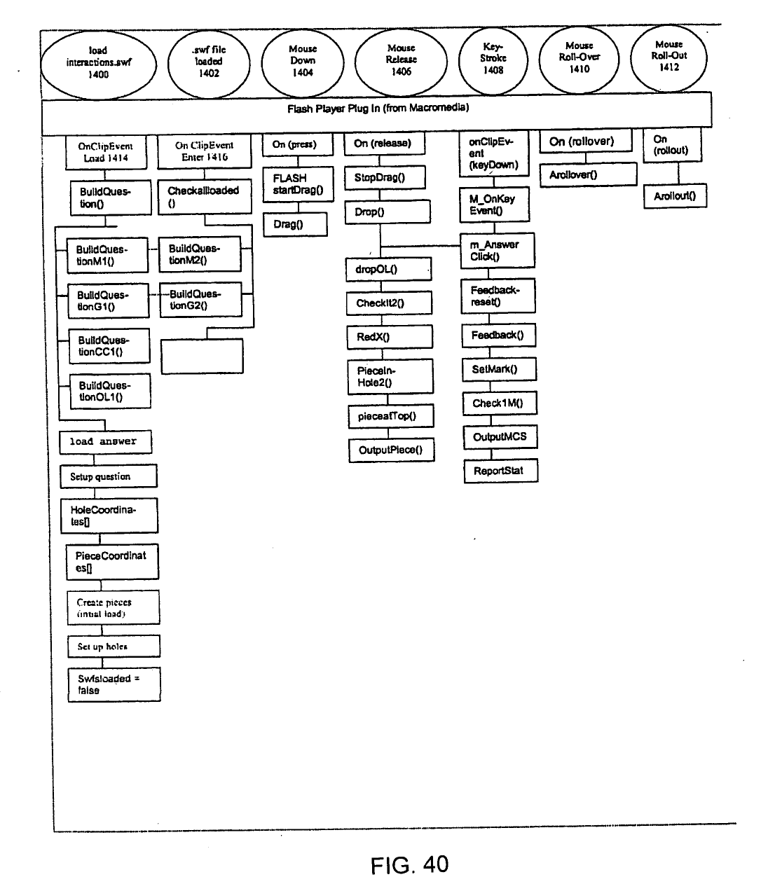

FIG. 40 is a block diagram software components associated with the XML player and interaction handler according to an embodiment of the invention. The components may include interaction scripts, which may be stored in a .swf file, such as an interaction.swf file, which is loaded 1400 and processed 1402 by a computer system. In particular, a flash player plug-in provides an interface between the interaction.swf file 1400 and a browser. The interaction.swf file 1400 accesses the flash player plug-in to determine and respond to various event types, which are typically the result of user interaction (e.g. mouse down 1404, mouse release 1406, key-stroke 1408, mouse roll-over 1410 and mouse roll-out 1412). The responses generated by software components invoke any number of event handlers, e.g. OnClipEvent 1414, OnClipEvent 1416, On (press), and the like. The event handlers can call a routine, such as the BuildQuestion routine to initialize the user interface and generate the interaction as discussed in more detail below.

The state of an interaction is stored in an array that may include an entry or indicator to reflect the status of the answer. Each answer has a corresponding indicator used to determine the current status of that answer. For example, an answer that is not selected can be indicated by a value of 1. Similarly, an answer that is selected but not checked can be indicated by a value of 2. In this way, it is possible to determine the current status of the answers provided by using the indicated value. Further, the current status can be dynamically updated in response to a change to provide accurate values. In addition to the status of the answer, the type and validity of an answer are stored in separate arrays. The answer type contains an indicator for each answer describing the type. For example, a “T” would indicate there was a text answer, whereas a “G” would indicate there was a Graphic answer. The answer's validity is provided in a separate array storing a flag describing the validity of the answer. For example, the array stores a value of “true” or “false” to represent whether or not an answer is correct.

An indicator may be used to identify whether a particular object or clone exists in a drag and drop environment. The indicator may be stored in an array. For example, the array contains a “0” when the object is not present. However, even if the object does not exist, a corresponding clone may exist, which may be indicated by an array value. In this way, the system is capable of determining what is available in the drag and drop environment. In addition, the array is used to denote the maximum number of times an object can be used in the interaction. For example, an array can contain the value “0” when the object is a distracter or a value “2” to represent it can be used twice.

For objects that are used only once a value is represented in the array to denote the correct location to place the object known as a hole. The hole's location is determined by making entries into an array. Each entry in the array has an X and Y value representing center point coordinates of the hole so as to determine the geographic location. Using the coordinate information, a second array identifies if the object is compatible with the hole. This array contains an object name or corresponding object value, e.g. “0”, used to determine compatibility. After finding a compatible location, yet another array is used to identify the object (e.g. piece) that is present. For example, an array is initialized to contain either an object name or a representation of an empty hole, e.g., “0”. In addition, the current status of each hole is stored using the array so that the status of the hole can be easily determined. Examples of hole status are: no piece present, present but not checked, wrong piece, right piece, or corrected to the right piece. Alternatively, a corresponding numeric value may be used to represent the above described status values.

Data used to create the interaction and store state information is stored in strings. This data includes questions, answers, feedback, remediation, and filenames specifying media files, such as graphics files. Further, parameters independent of the particular question, but controlling the operation of the interaction, such as allowing an incorrect answer to be seen by the user, are stored. In addition, state memory be used to allow the user to change the answer of a previous question before it is graded. This information may be stored into a string. For example, variables may be associated with these values. When the table is stored into a string and then processed into an array, an interaction can be initialized. Information about the interaction identified in the table can be stored as variables into an array.

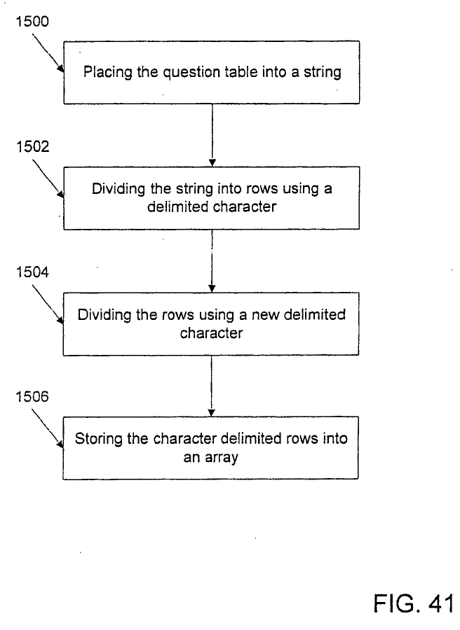

FIG. 41 is a flow diagram depicting the process of storing variables from a question table into strings. For example, at 1500, the question table is placed into a string. At 1502, the string is divided into rows using a delimiting character such as “|”. At 1504, the resulting rows from 1502 are divided using a new delimiter, such as a tab character. At 1506, the character-delimited row(s) of 1504 are stored into an array where each element of the array represents a row or question. In this way, the array will be populated using the values of all strings from the question table, and the original cell, row configuration of the table can be preserved.

To build a question from a table for an interaction, the type of interaction is determined based on a pattern or indicators in a table. Artificial intelligence heuristics may be used to determine a pattern in the table. These heuristics include an assessment of the contents of rows and cells, which may be stored in an array. It is important to note that rows and cells stored in an array are typically numbered starting with zero, e.g., zeroth row or zeroth cell.

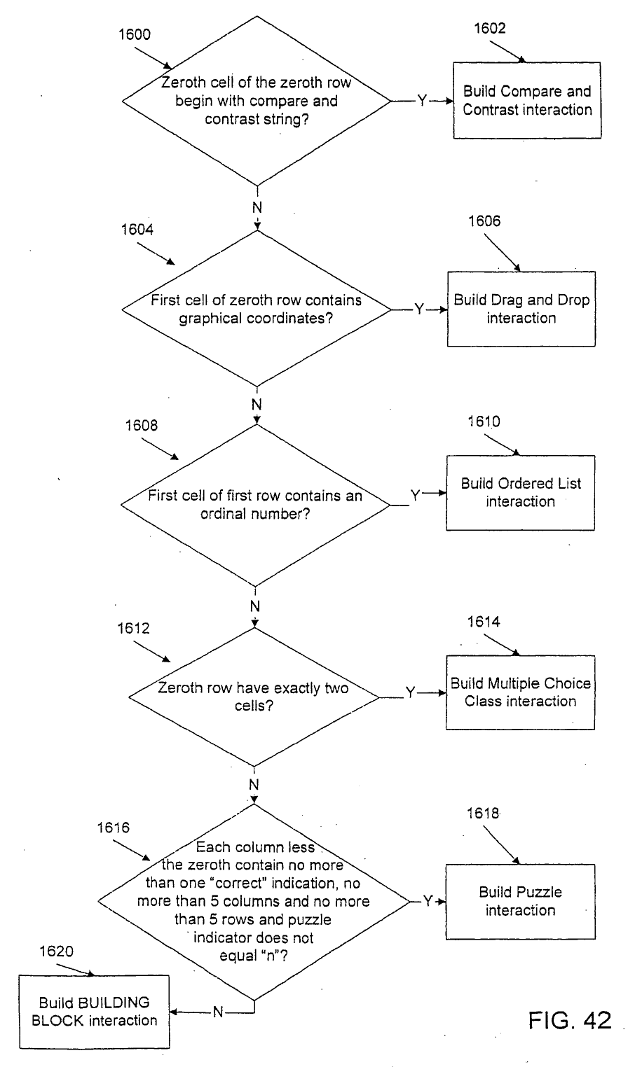

FIG. 42 is a flow diagram of the process of determining a type of interaction based on the contents of a table according to an embodiment of the invention. At 1600, if the zeroth cell of the zeroth row begins with a building block string, the process moves to 1602 to build a building block interaction. If it is not a building block interaction, the process proceeds to 1604 to determine whether the first cell of the zeroth row contains graphical components. If graphical components are specified, the process moves to 1606 to build a drag and drop interaction. If the graphical components are not specified, the process proceeds to 1608. At 1608, if the first cell of the first row contains an ordinal number, the process moves to 1610 to build an ordered list interaction. If there is no ordinal number, the process proceeds to 1612. At 1612, the process determines whether the zeroth row has exactly two cells. If there are exactly to cells, a multiple choice class interaction is specified in the cell. Otherwise, the process proceeds to 1616 to determine if each column (other than the zeroth) contains: 1) no more than one special “correct” indication, 2) no more than five columns, 3) no more than five rows, and 4) a puzzle indicator with a value of “n”. If this condition is met, the process builds a puzzle interaction 1618. Otherwise, at 1620, the process determines that the interaction is building block interaction, which is the default interaction type.

The interactions may be initialized with user-supplied graphics or predefined graphics. When loading the graphics, the system software (e.g. the interaction player and interaction handler in communication with the flash plug-in) balances the graphical layout. Usually, the size of user-supplied graphics is determined at run-time after the graphics have been loaded. This run-time determination, however, may result in an absent size making screen locations difficult to accurately calculate. In response to this problem, the graphics may be loaded into a location on a screen other than the graphics' final location. However, displaying this to a user would be disconcerting, especially one with slow transfer time from the server providing the graphics. Using an event handler, this graphics-loading problem can be resolved. The following is an example of an event handler script according to an embodiment of the invention:

```
onClipEvent (enterFrame) {
    //_root.testbox = “onClipEvent”;
    if (not_root.swfsloaded) {
        checkallloaded( );
        //
    }
    if (not_root.cswfsloaded) {
        checkallcloaded( );
        //
    }
    //_root.testbox += “1”;
```

As each user-supplied graphic completes loading, that event is processed in a routine, such as checkallloaded( ), which immediately sets the visibility of the graphic to zero (invisible) to avoid the above user disconcertion. Assuming other graphics are still being loaded, the system software automatically relinquishes control to the Flash Plug-in to await the next event, which is typically the loading of another graphic.

When all graphics have been loaded, the second phase of initialization occurs in a second initialization routine. In the second phase of initialization, the height and width of each graphic image can be determined and the advanced heuristical algorithms may be used to define the layout of the screen by assigning scale factors and coordinates to both the user-supplied graphics and to the predefined graphics and text.

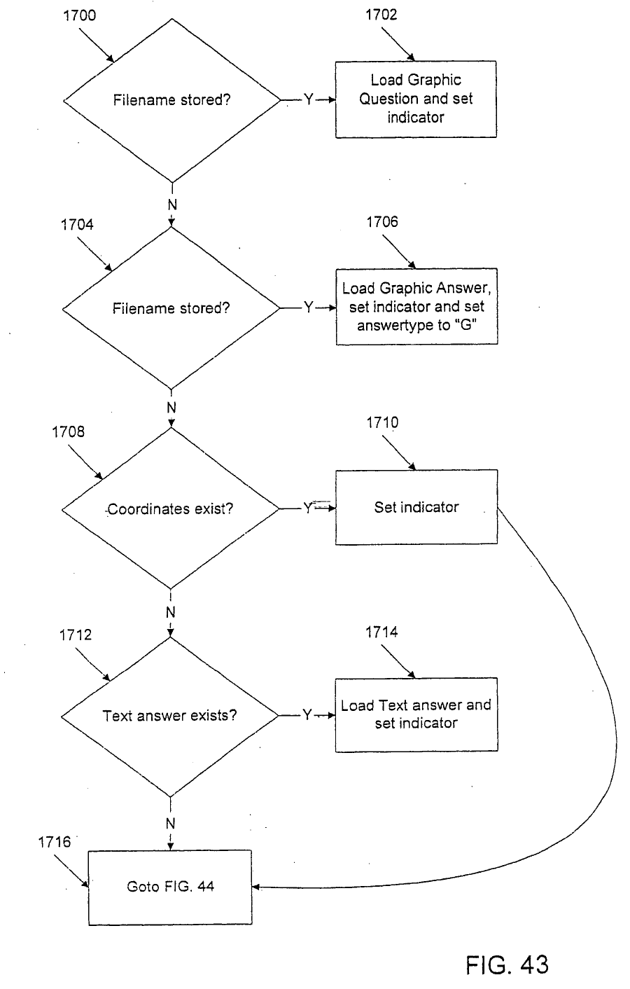

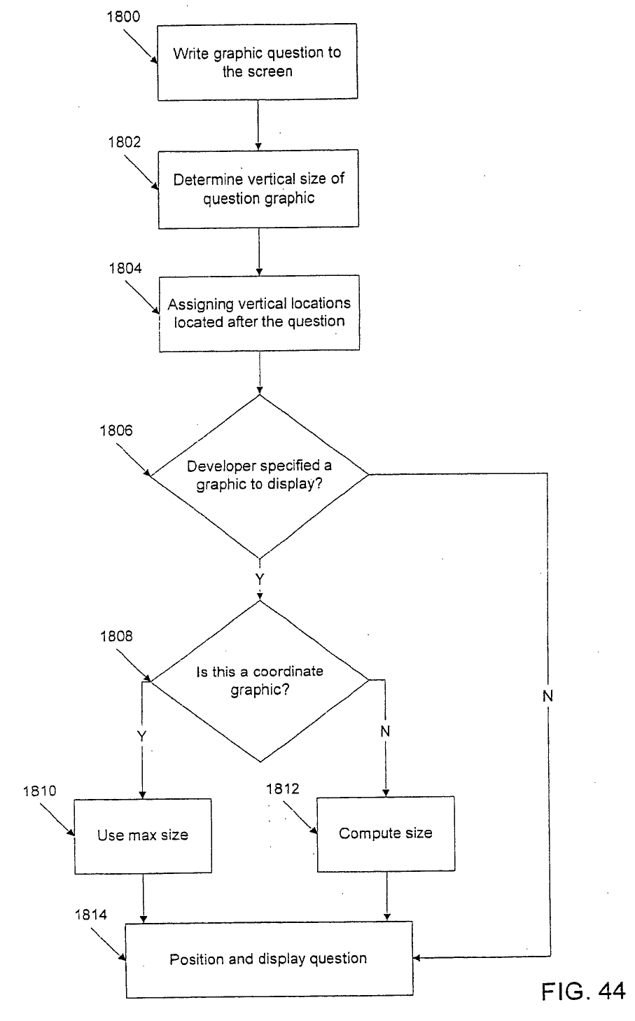

FIG. 43 is a flow diagram depicting the process of how questions are stored into an array. At 1700, if a stored filename exists and the position in the array represents a question location, such as row zeroth, then a graphic question is loaded and an indicator is set, e.g., typeG=true, at 1702. If the condition of 1700 is not satisfied, the process proceeds to 1704. At 1704, if a stored filename exists and the position in the array represents a answer location, such as row two, then a graphic answer is loaded and multiple indicators are set, e.g., typeGA=true and AnswerTypes[i]=“G” at 1706. If the condition of 1704 is not satisfied, the process proceeds to 1708. In 1708, a developer can optionally provide coordinate answers. The developer can identify the center of a hotspot with a special pair of coordinates, such as “(x,y)”, where x and y are integers addressing the center of the hotspot on the question graphic. Alternately, the developer can identify the upper left-hand and lower right-hand corners with two coordinate pairs, such as “(x1,y1)−(x2,y2).” The average height and width of the hotspots are computed, such as in the variables dropzone_width and dropzone_height, to be used to compute an appropriate size for the checkboxes and letter identifiers. If the answer coordinate was provided by the developer, an indicator is set in 1710, e.g., AnswerTypes[i]=“C”. After setting the coordinate indicator, the process proceeds to 1716 for displaying and sizing, e.g., FIG. 44. However, if the condition of 1708 is not satisfied, the process proceeds to 1712. At 1712, if a text answer exists, an indicator is set and the text answer is loaded in 1714. If the condition of 1712 is not satisfied, the process proceeds to the steps of FIG. 44 for displaying and sizing in 1716.

Once developer-supplied graphics are loaded, the graphics display will be sized properly. FIG. 44 is a flow diagram of the process of scaling graphics used when loading an interaction. At 1800, the question is displayed on the screen and the actual vertical size (in pixels) of the question is determined by a routine at 1802. The vertical locations determined at 1802 are used to calculate vertical locations used to place the graphic following a question. These locations are assigned to the graphic at 1804. However, if the developer did not specify a graphic in 1806, the process proceeds at 1814 to appropriately position and size the graphics for the question. If the developer specified a graphic to display after the question, the process determines whether the drag and drop coordinates for the graphic were specified. At 1808, if coordinate answers were specified, the graphic is scaled to a maximum of 240 pixels vertically at 1810, otherwise, the size is computed at 1812.

Interactions that have previously been configured may be reused to enable faster user access. Reusing an existing interaction avoids re-loading and re-interpreting. This faster access is accomplished by using variables that are all initialized in a common place. Further, tables are used to store any objects previously loaded. In this way, variables and tables can be used to provide prior configurations for faster user access.

Another important aspect of reusing the interface generated by the system is to ensure the colors remain in high contrast. Ensuring high contrast can be accomplished using a single variable containing the HTML code for that color. In this way, the system is capable of ensuring high contrast when reusing an interface with minimum processing overhead.

Drag and drop is an important feature in modem graphical user interfaces. In one embodiment, a drag and drop process may select a source object and a destination hole to associate the source object to the destination hole. With this information, an object can be dragged and dropped. In addition to moving an object, there are visual effects shown during the drag and drop operation, such as soft animation, which makes the impression of a source object being “dragged” across the screen to a destination object.

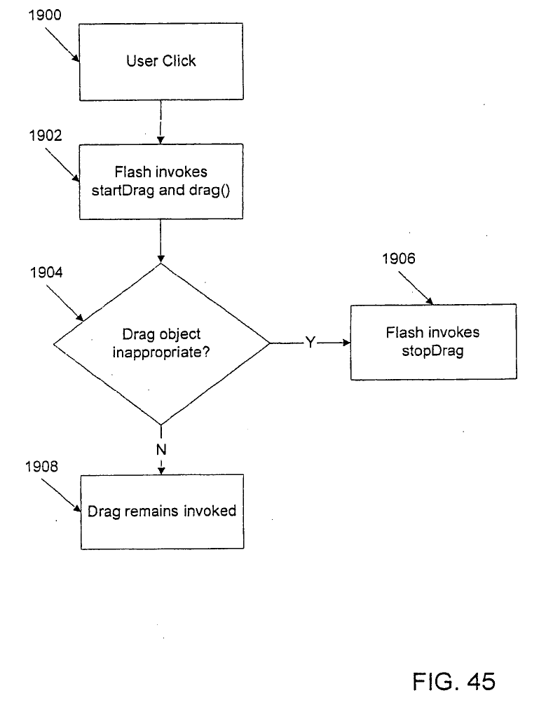

FIG. 45 is a flow diagram depicting an aspect of the drag and drop process. a user can drag a stationary object on the screen. At 1900, a user clicks on an object and Flash invokes the StartDrag function as well as a routine such as DragO in 1902. If the object is inappropriate to drag, Flash immediately invokes the StopDrag in 1906. This assures that these objects cannot be dragged by stopping control before the object could be moved. Examples of inappropriate dragging objects are: multiple choice/multiple select/dichotomous, pseudo pieces filling unused puzzle holes, pieces already checked correctly, or any object in an interaction with no remaining attempts. However, if the object is appropriate to drag, the process proceeds to 1908 where the dragging function remains invoked. This enables the user to drag the object to another location on the screen for dropping.

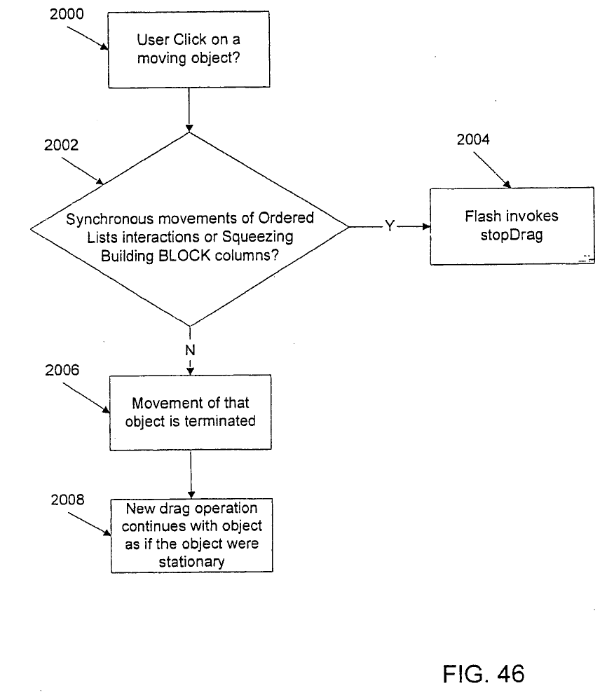

Even though dragging may seem like a simple Flash procedure, it becomes more complicated when a user attempts to drag a moving object. FIG. 46 is a flow diagram depicting the process of dragging a moving object on the screen. At 2000, a user clicks on an object that is moving on the screen. At 2002, if the object is either a synchronous movements of ordered lists or a squeezing building block columns interaction, the object will not be dragged. In fact, either of these interactions types will result in Flash immediately invoking StopDrag in 2004 because these interactions are not movable. Otherwise, if the condition of 2002 has not satisfied, the process proceeds to 2006. At 2006, movement of the object is terminated enabling the new drag operation to continue normally in 2008, so as to mimic if the object were stationary when the user clicked.

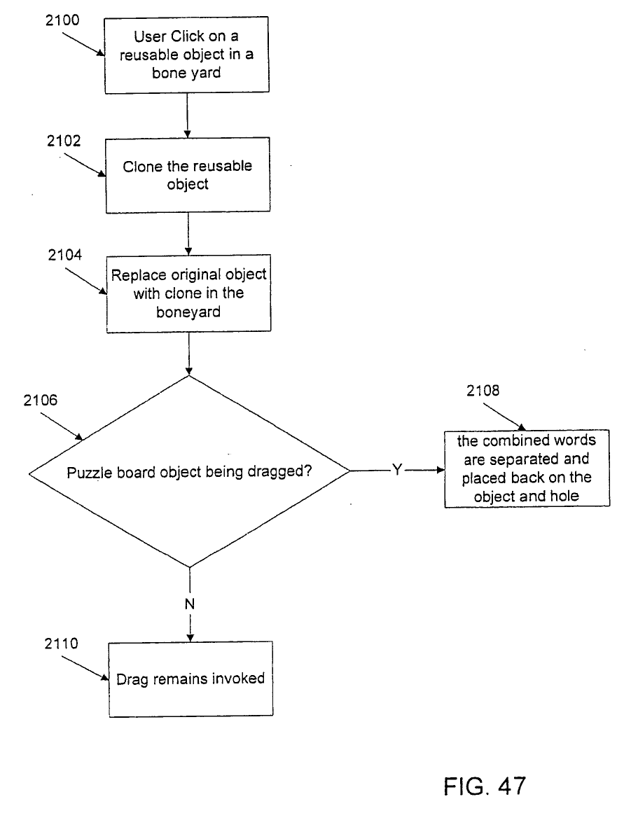

FIG. 47 is a flow diagram depicting the process of dragging a reusable object. At 2100, a user clicks on a reusable object in a bone yard. At 2102, the reusable object is cloned, and at 2104 the original object from the bone yard is replaced. At 2106, if the object, which the user is dragging, is part of a puzzle board, the combined words are separated and placed back on the object and hole respectively in 2108. Otherwise, if the condition of 2106 is not satisfied, the process proceeds to 2110. At 2110, dragging of the object remains invoked.

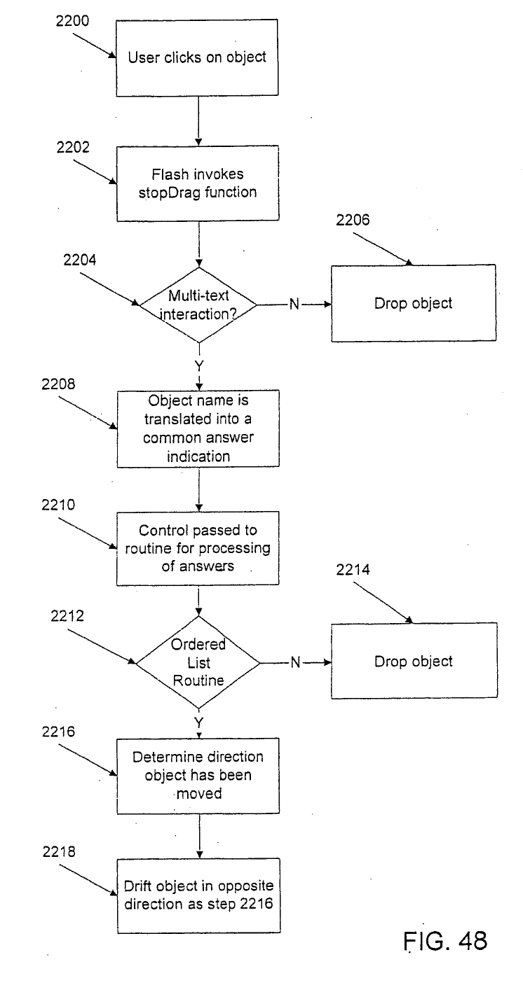

After dragging an object, a user makes a decision of where to drop the item in order to complete the move. FIG. 48 is a flow diagram depicting the process of dropping an object. At 2200, a user clicks on an object that will invoke a routine such as Drop( ). In response to 2200, Flash invokes its StopDrag function in 2202. At 2204, if a Multi-text interaction was selected, the object name is translated into a common answer indication at 2208, such as a positive integer, next the process proceeds to 2210 where control is passed to a routine that processes Multi-text interaction user answers, such as m_AnswerClick( ). In contrast, if this is not a Multi-text interaction, the process proceeds to 2206 to drop the object.

At 2212, if an ordered list routine exists, control is passed to another routine, such as DropOL( ), which determines whether the object has been moved up or down in 2216. Based on the movement of the object at 2216, 2218 will drift the object in the opposite direction to a proper resting position. Refer to Object Animation section below for more detail.

It is important to note that a developer has the ability to allow an object to be dropped in an incorrect hole using the checkit feature. If the developer has specified checkit=“y” a CheckIt button is displayed on the interaction, CheckIt changes the way the drop routines operate. The CheckIt feature allows a user to drop an object into an incorrect hole. On the other hand, if the developer specified checkit=“n” then no CheckIt button appears thus preventing a user from dropping an object in an incorrect hole. In the event a user attempts to drop an object into an incorrect hold, a diagnostic message is issued above the instruction area. However, a developer may supply feedback that will be supplied instead of the diagnostic message. After the learner views the message on feedback, the object is smoothly animated while returning to the boneyard.

The learner's experience is enhanced for incorrect answers on exercises using immediate CheckIt, i.e. no CheckIt button. The learner gets three immediate incorrect indications:
i) The object refuses to stick where dropped, but rather drifts back to the boneyard at three different velocities to move smoothly but rapidly to avoid delaying the next attempt;
ii) The object is marked with a red X; and
iii) The incorrect slot (hole) is marked with a red X.

When the learner next picks up any piece, both red Xs disappear.

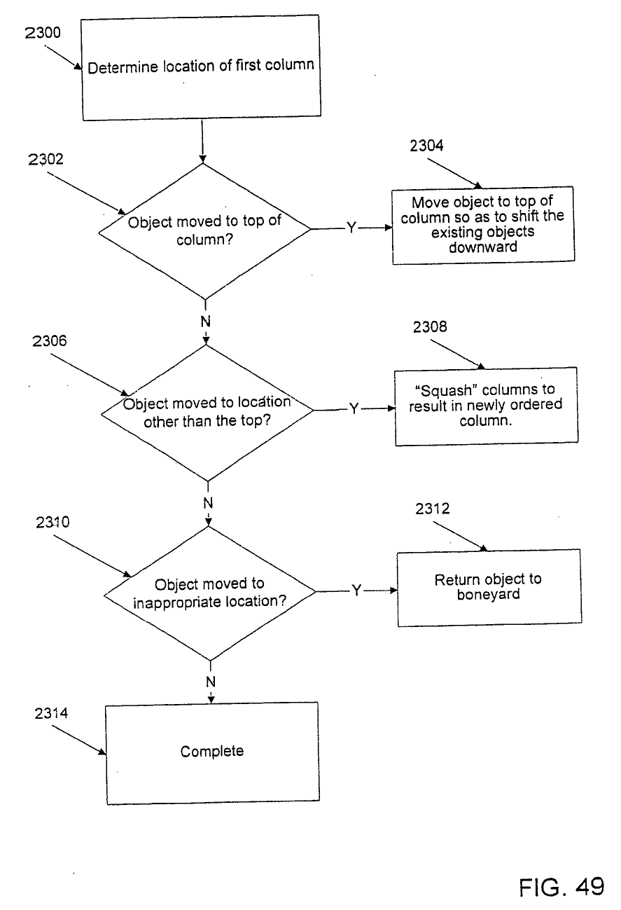

FIG. 49 is a flow diagram of the process of moving a building block object. At 2300, the location of the first building block column is determined. At 2302, if the top position of the column is capable of receiving a building block object, the object is moved to the top of the column in 2304. If the top position is not capable of receiving a building block, the process proceeds to 2306. At 2306, if the user moves a building block object from a column location other than the top, the column is “squashed” by a routine such as cc_straighten. Complex logic smoothly moves the objects above the hole while placing the object in its new location.

In general, the movement of objects is initiated by two routines, such as ObjectAtTop( ) to move an object to the bone yard, and ObjectInHole( ), e.g.
_root.tweeninghole[root.tweeninghole.length]=1_Hole;
_root.tweeningholeobject[root.tweeningholeobject.length]=1_ObjectName;

However, at 2310, if the user drops the object into an inappropriate location, such as over an unchecked object, the original object is smoothly returned to the boneyard in at 2312. It is important to note that the developer may specify that for a drag and drop or building block interaction, several holes are all to be filled with a single graphic, called a reusable object. In this way, the original object is capable of being reused in different locations within a single interaction.

In Flash, in order to achieve smooth animated movement, the pixel coordinates are recalculated every 1/16 of a second (assuming the frame rate is 16 fps). Further, a constant velocity appears time-consuming for long movements, whereas the user may miss the movement for short movements. In one embodiment, animations are generated with movements that are fast for initial long distances, then decelerate for gentle movement into the destination.

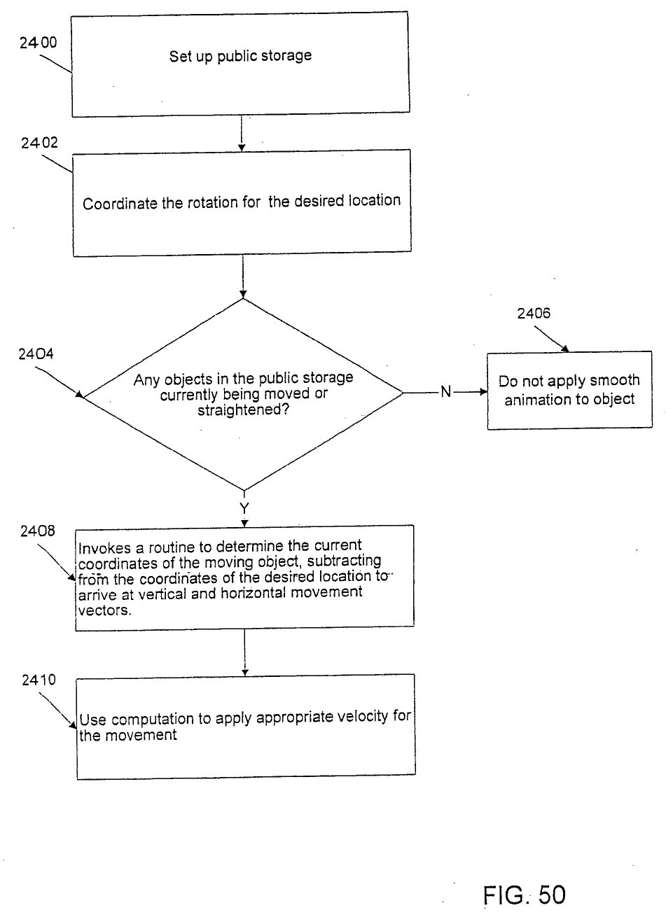

Further, this supports simultaneous movement of many objects into the destination. This presents a more pleasing picture to the user both when showing the correct answer and when using the different interfaces. To ensure a pleasing picture to the user, the objects can be moved fluidly. FIG. 50 is a flow diagram of the process of moving an object. In order to move an object, a public storage must be set up (2400), such as an array, with an object name as well as coordinating and rotating the desired location as at 2402. At 2404, the public storage is examined, by a Flash invoked function, to determine whether any object is currently being: (1) moved closer to the boneyard; (2) straightened in a column; or (3) move closer to a hole. If the object at 2404 does not satisfy this condition, the process proceeds to 2406 where the object is not animated for smooth movement. Otherwise, at 2408, if an object is currently being oved or straightened, several routines are invoked, such as tweentop( ); tweenstraighten( ); and/or tweenhole( ). These special routines first determine the current coordinates of the moving piece, subtracting from the coordinates of the desired location to arrive at vertical and horizontal movement vectors. To avoid the computational intensity of the Pythagorean Theorem, the hypotenuse is estimated by the simple formula: hypotenuse=abs(horizontal movement)+abs(vertical movement)*1.4.

Using these mathematical computations, the system can move many objects smoothly, even on a user's slow computer. Accordingly, the system computes at 2410 an appropriate velocity for this stage of the movement from the length of the hypotenuse. When making a long move, e.g. over 200 pixels, the object is initially moved at 50 pixels per frame (ppf), then at 30 ppf until the object is within 90 pixels of the desired location, at which time it slows down to 8 ppf. Finally, the object is moved at 4 and then 2 ppf as it gets within 8 and 4 pixels, respectively. This is calculated by dividing the pixels to be moved this frame by the total pixels to be moved (hypotenuse) to produce a quotient, then the quotient is multiplied by both the horizontal and vertical deltas. Next, the products are given the proper algebraic sign to become movement vectors. It is important to note that if a rotation change of the frame is necessary to compute, it can be done by adding the existing rotation to the remaining rotation and dividing the sum by the percentage of the X distance being moved this frame.

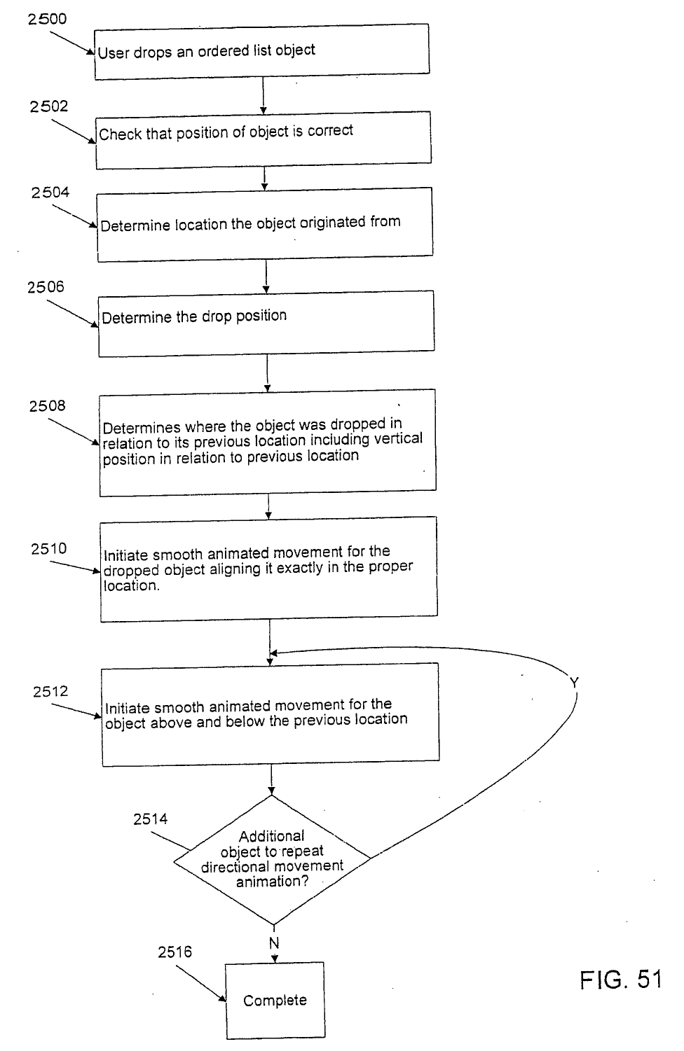

FIG. 51 is a flow diagram of the process of dropping an ordered list object. When the user drops an ordered list object at 2500, a special routine, such as dropOL( ), is invoked. The following process is performed when dropping an ordered list object:
1) 2502 checks to see if the positions of the object are correct;
2) 2504 determines a hole from which the object came and sets a variable, such as 1_oldhole to the old location;
3) 2506 determines the drop position. It is important to determine if the object is being dropped on another object or between pieces;
4) 2508 determines where the object was dropped in relation to its previous location. Specifically, it is determined how far away the object was dropped and whether the object is above or below the previous location;
5) 2510 initiates smooth animated movement for the dropped object aligning it exactly in the proper hole;
6) 2512 initiates smooth animated movement for the object above or below the previous location while directing it towards the previous location; and
7) 2514 repeats the process of 2512 for every object above or below the previous location, until smooth animated movement is initiated for each object occupying the desired location.

A user to check optionally check the answered question immediately, or to go and view other questions. Any questions not individually requested to be checked by the user are automatically checked at the end of the question sequence.

This optional checking feature requires non-volatile memory. The interaction program stores the complete state of the current interaction in memory. This non-volatile memory is updated with every user action, since in this event-driven environment, the user can leave the interaction by manipulating an external button, such as a button within a table of contents, or the exit button of the browser.

One implementation of non-volatile memory is to arrange for it to be stored by the Learning Management system (LMS). Since space within the LMS is limited, this system stores the state compactly, such as with a string of bytes and Extendedbytes (Xbytes). Xbytes are a novel way of storing ASCII. The numbers 0-9 are still represented by their ASCII equivalent (octal 060-071), and thus can easily be inspected. For applications with more than 9 answers, the value 10 is stored as 071+1, 11 is stored as 071+2, etc. In this way, Xbyte allows simple one-line subroutines to easily convert between integers and ASCII characters.

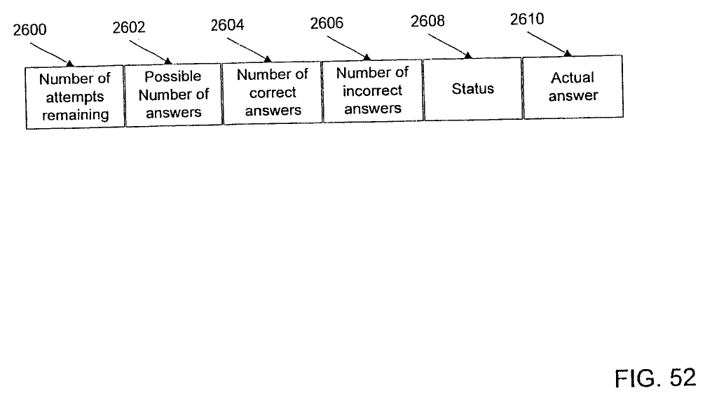

To store the state of an interaction, a routine, such as ReportStatus( ), can build a string, as shown in FIG. 52. FIG. 52 is a schematic diagram of the attributes stored in a string according to an embodiment of the invention. The string is configured as follows:
1) One byte: Number of developer-specified attempts remaining (0-9) see 2600;
2) One Xbyte: Possible number of answers (1-25) see 2602;
3) One Xbyte: Number correctly answered (whether checked or not) (0-25) see 2604;
4) One Xbyte: Number incorrectly answered (whether checked or not) (0-25) see 2606;
5) One byte per possible answer of status of that answer (unanswered, unchecked, wrong, right, corrected; for example indicated by 1, 2, 3, 4 or 5 see 2608; and
6) One Xbyte per possible answer of the actual answer (0-25 to correspond to an answer/piece) see 2610.

The stored states of the interaction can be examined by a calling program. The calling program examines status color indications that allow a “MyAnswer” button to become activated providing the user with complex interactions. The “MyAnswer” button provides the user answers upon request based on the stored string information.

A granular scoring system may be used that calculates answer percentages based on the number of correct elements in the test, rather than the number of incorrect answers divided by the total number of questions in the test. It scores on both a question-by-question and total test basis. This system allows for the granting of both full and partial credit, thereby offering a great deal more information about a user's depth of knowledge. In this way, the user is capable of receiving feedback on a question-by-question basis or on a total basis based on the user's preference.

It will be apparent to those of ordinary skill in the art that methods involved in the Interactions for Electronic Learning System can be embodied in a computer program product that includes a computer usable medium. For example, such a computer usable medium can include a readable memory device, such as a hard drive device, a CD-ROM, a DVD-ROM, or a computer diskette, having computer readable program code segments stored thereon. The computer readable medium can also include a communications or transmission medium, such as a bus or a communications link, optical, wired, or wireless, having program code segments carried thereon as digital or analog data signals.

It will further be apparent to those of ordinary skill in the art that, as used herein, “interactive presentation” or “interaction” can be broadly construed to mean any electronic simulation with text, audio, animation, video or media asset thereof directly or indirectly connected or connectable in any known or later-developed manner to a device such as a computer.

While this invention has been particularly shown and described with references to particular embodiments, it will be understood by those skilled in the art that various changes in form and details may be made without departing from the scope of the invention encompassed by the appended claims.

1. A computer implemented method of creating an interaction comprising:
processing content stored in a data table; and
extracting the data table content to create an interaction, where the interaction is based on the data table content.

2. A computer implemented method according to claim 1 wherein extracting the data table content further includes storing the data table content into a string.

3. A computer implemented method according to claim 2 wherein storing the data table content into a string further includes:
determining an arrangement of the data table content from the data table; and
preserving the arrangement of the data table content in the string.

4. A computer implemented method according to claim 3 wherein preserving the arrangement of the data table content in the string further includes:
dividing the string into rows, where the rows reflect rows from the data table;
dividing the rows into cells, where the cells reflect cells from the data table including any data table content associated with the cells.

5. A computer implemented method according to claim 4 further including:
defining the rows of the string using a respective row delimiter character; and
defining the cells of the string using a respective cell delimiter character.

6. A computer implemented method according to claim 3 further including:
parsing the string to identify the preserved data table content; and
storing the preserved data table content into at least one array.

7. A computer implemented method according to claim 6 wherein storing the preserved data table content into at least one array further includes defining each element of the array as a row array, where each element of the row array includes a cell array.

8. A computer implemented method according to claim 7 wherein the combination of the row array and cell array further comprises a two dimensional array.

9. A computer implemented method according to claim 1 wherein extracting the data table content to create an interaction further includes determining a type of interaction based on the data table content.

10. A computer implemented method according to claim 9 wherein the type of interaction indicates behaviors associated with the interaction.

11. A computer implemented method according to claim 9 wherein the type of interaction is at least one of the following: multiple choice, multiple select, dichotomous, ordered list, or matching.

12. A computer implemented method according to claim 11 wherein the multiple choice interaction further comprises a fill in the blank interaction.

13. A computer implemented method according to claim 11 wherein the matching interaction further includes a plurality of questions, where each question has zero or more answers.

14. A computer implemented method according to claim 11 wherein the matching interaction further includes determining drag and drop objects.

15. A computer implemented method according to claim 14 wherein the drag and drop objects are at least one of: puzzle pieces, building blocks, developer supplied graphics or labels.

16. A computer implemented method according to claim 14 wherein each of the drag and drop objects correspond to an answer to one or more questions.

17. A computer implemented method according to claim 16 wherein each answer corresponds to a character string stored in a cell of the data table.

18. A computer implemented method according to claim 16 wherein determining drag and drop objects further includes:
determining an arrangement of cells in the data table;
determining which cell contains the answer.

19. A computer implemented method according to claim 11 further including determining that the matching interaction corresponds to at least one of the following models: drag and drop interaction, label drag and drop interaction, puzzle interaction, or building block interaction.

20. A computer implemented method according to claim 19 wherein the puzzle interaction reflects a jigsaw puzzle.

21. A computer implemented method according to claim 20 wherein the jigsaw puzzle has four identically-shaped pieces.

22. A computer implemented method according to claim 11 wherein determining a type of interaction based on the data table content further includes at least one of:
assessing which row and cell contains a question;
assessing which row and cell contains an answer;
assessing whether any cell contains graphical coordinates; or
assessing whether any cell contains a string that identifies the type of interaction.

23. A computer implemented method according to claim 1 wherein the data table content corresponds to interaction logic.

24. A computer implemented method according to claim 1 wherein the data table further includes one or more cells containing at least one of the following: question, answer, feedback, graphical coordinates, media filename, or character string.

25. A computer implemented method according to claim 1 wherein the interaction is part of at least one of: test, exam, or evaluation.

26. A computer implemented method according to claim 1 wherein an interaction uses a granular scoring system.

27. A computer implemented method according to claim 26 further including processing the interaction by evaluating one or more user responses based on the granular scoring system.

28. A computer implemented method according to claim 27 wherein evaluating one or more user responses based on the granular scoring system further includes providing a user with at least one of: an answer to a question on a question by question basis, partial credit for an answer, or full credit for an answer.

29. A computer implemented method according to claim 1 wherein the data table is embedded in a word processing document.

30. A computer implemented method according to claim 1 wherein the interaction further includes a Checkit feature that provides a user with any developer created diagnostic messages or feedback.

31. A computer implemented method according to claim 30 wherein the Checkit feature determines whether a user has dropped an object into an incorrect hole.

32. A computer implemented method according to claim 1 further including:
determining an interaction state associated with the interaction; and
storing the interaction state.

33. A computer implemented method according to claim 32 wherein storing the interaction state further includes monitoring user interaction.

34. A computer implemented method according to claim 33 monitoring user interaction further includes at least one of:
determining a number of retry attempts are made to answer a question associated with the interaction;
determining a number of answers selected;
determining a number of correct answers;
determining a number of incorrect answers; or
determining a score associate with one or more interactions.

35. A computer implemented method according to claim 32 further including storing the interaction state as attributes of one or more strings.

36. A computer implemented method according to claim 1 wherein creating the interaction further includes causing graphics associated with the interaction to be invisible while the graphics are loading.

37. A computer implemented method according to claim 36 wherein causing graphics associated with the interaction to be invisible while the graphics are loading further includes scaling the graphics based on a screen size associated with a user interface.

38. A computer implemented method according to claim 1 wherein the data table is the authoring environment for developing the interaction.

39. A computer implemented method according to claim 1 further including enabling the data table to be sent electronically by email.

40. A computer implemented method according to claim 39 further including:
receiving an emailed data table; and
generating the interaction based on the emailed data table.

41. A computer learning system to create an interactive presentation comprising:
an interaction handler to process content extracted from cells of a data table to create an interactive presentation; and
a player, in communication with the interaction handler, generating the interactive presentation based on the extracted content from the data table.

42. A computer learning system as in claim 41 further including an interaction builder to extract content from a data table.

43. A computer learning system as in claim 42 wherein the interaction builder causes the extracted content to be stored into a string.

44. A computer learning system as in claim 43 wherein the string is divided into cells and rows to reflect a structure associated with the data table.

45. A computer learning system as in claim 41 wherein the interaction handler causes the extracted content to be stored into an array.

46. A computer learning system as in claim 41 wherein generating the interactive presentation based on the extracted content further includes determining a type of interaction associated with the interactive presentation, where the type of interaction is based on the extracted content from the data table.

47. A computer learning system as in claim 46 wherein the type of interaction corresponds to at least one of the following: multiple choice, multiple select, dichotomous, ordered list, or matching.

48. A computer learning system as in claim 47 wherein the matching interaction further including drag and drop objects.

49. A computer learning system as in claim 48 wherein each of the drag and drop objects corresponds to an answer to one or more questions.

50. A computer learning system as in claim 49 wherein each answer corresponds to a character string stored in a cell of the data table.

51. A computer learning system as in claim 47 wherein the matching interaction corresponds to at least one of the following: drag and drop, label drag and drop, puzzle, or building block.

52. A computer learning system as in claim 51 wherein the puzzle interaction reflects a jigsaw puzzle.

53. A computer learning system as in claim 46 wherein the type of interaction determined by the interaction handler by at least one of the following:
assessing which row and cell contains a question;
assessing which row and cell contains a answer;
assessing whether any cell contains graphical coordinates; or
assessing whether any cell contains a character string that identifies the type of interaction.

54. A computer learning system as in claim 41 wherein the extracted content further includes at least one of the following: question, answer, feedback, graphical coordinates, media filename, or character string.

55. A computer learning system as in claim 41 wherein the data table is embedded in a word processing document.

56. A computer learning system as in claim 41 wherein the player further includes logic which determines the state of the interactive presentation, where the state corresponds to one or more interactions associated with the interactive presentation.

57. A computer learning system as in claim 41 wherein determining the state further includes assessing at least one of: a number of attempts to answer a question associated with one of the interactions, a number of correct answers associated with one of the interactions, or a number of incorrect answers.

58. A computer learning system as in claim 41 wherein the state is stored in a string.

59. A computer learning system as in claim 41 wherein generating the interactive presentation based on the extracted content further includes generating computer executable code based on a type of interaction specified in the data table.

60. A software system for creating an interaction comprising:
means for processing content stored in a data table; and
means for extracting the data table content to create an interaction, where the interaction is based on the data table content.

61. A method of creating interactions in a data processing system comprising:
identifying content stored in a word processing document associated with an interaction; and
processing the content stored in the word processing document to generate an interaction.

62. A method of creating interactions as in claim 61 wherein the word processing document is an authoring environment for defining the interaction.

63. A method of creating interactions as in claim 61 wherein the content stored in the word processing document is embedded in a data table.

64. A method of creating interactions as in claim 63 wherein the data table content is extracted and stored as attributes of a string.

65. A method of creating interactions as in claim 64 wherein the attributes of the string are stored into an array.

66. A method of creating interactions as in claim 63 wherein processing the content stored in the word processing document to generate the interaction further includes using the content stored in the data table to determine a type of interaction.

67. A method of creating interactions as in claim 64 wherein the type of interaction is at least one of: multiple select, multiple choice, dichotomous, fill in the blank, ordered list or matching interaction.

68. A method of creating interactions as in claim 65 wherein the matching interaction further includes at least one of: puzzle, building block, or label drag and drop interaction.

69. A software system to create interactions comprising:
a word processing document storing content for an interaction;
a builder, coupled to the word processing document, that uses the content stored in the word processing document to determine the interaction.

70. A software system comprising:
means for identifying content stored in a word processing document associated with an interaction; and
means for processing the content stored in the word processing document to generate an interaction.

71. A computer implemented method according to claim 11 wherein a row in the table includes one or more cells specifying answers associated with the interaction.

72. A computer implemented method according to claim 71 wherein a column in the table includes one or more cells specifying questions associated with the interaction.

73. A computer implemented method according to claim 72 further including:
examining the cells at an intersection between the answer row and the question column to identify whether the interaction type is a matching interaction.

74. A computer implemented method according to claim 73 wherein determining the intersection between the answer row and the question column to identify whether the interaction type corresponds to a matching interaction further includes identifying a character string, which indicates whether an answer is correct or incorrect.

75. A computer implemented method according to claim 74 wherein the correct or incorrect answer further includes feedback.
